(19) United States
(12) Patent Application Publication
(10) Pub. No.: US 2026/0358900 A1
(43) Pub. Date: Nov. 12, 2026

(54) CONTROLLER APPARATUS AND SYSTEM FOR HUMAN-MACHINE INTERACTIONS

(71) Applicant: QUALCOMM Incorporated, San Diego, CA (US)

(72) Inventors: Wentao MAO, Beijing (CN); Xu ZHANG, Beijing (CN); Zhaohui ZHANG, Beijing (CN)

(21) Appl. No.: 19/478,227

(22) PCT Filed: Jun. 3, 2024
(86) PCT No.: PCT/CN2024/097027

§ 371 Date: Oct. 23, 2025

(30) Foreign Application Priority Data
Jun. 25, 2023 (WO) PCT/CN2023/102055

(51) Int. Cl. G06F 3/03; G06T 7/70

(52) U.S. Cl. CPC G06F 3/0325; G06T 7/70

(57) ABSTRACT

Systems and techniques are described herein for enabling tracking of an object. For instance, an apparatus for enabling tracking of an object is provided. The apparatus may include a body comprising a handle; a plurality of light sources arranged on the body; and at least one processor configured to control the plurality of light sources to enable an object-tracking system to track the body based on images of the plurality of light sources. Additionally, systems and techniques are described herein for tracking an object. For instance, an apparatus for tracking an object is provided. The apparatus may include a camera configured to capture a plurality of images of a tracked object; a communication unit configured to send signals to the tracked object; and at least one processor configured to determine a pose of the tracked object based on the plurality of images of the tracked object.

### CROSS-REFERENCE TO RELATED APPLICATIONS

This application claims the benefit of PCT International Application PCT/CN2023/102055 filed Jun. 25, 2023, which is incorporated herein by reference in its entirety.

### TECHNICAL FIELD

The present disclosure generally relates to human-machine interactions. For example, aspects of the present disclosure include systems and techniques a controller apparatus for human-machine interactions.

### BACKGROUND

A handheld controller is an example of a human-machine-interface (HMI) device. Such a handheld controller may allow a user to interact with a machine by pressing buttons on the handheld controller and/or through a position and/or motion of the handheld controller. Handheld controllers can be used with extended-reality (XR) systems.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary presents certain concepts relating to one or more aspects relating to the mechanisms disclosed herein in a simplified form to precede the detailed description presented below.

Systems and techniques are described for enabling tracking of an object. According to at least one example, an apparatus includes: a body comprising a handle; a plurality of light sources arranged on the body; and at least one processor configured to control the plurality of light sources to enable an object-tracking system to track the body based on images of the plurality of light sources.

In another example, a method is provided for enabling tracking of an object. The method includes: controlling a plurality of light sources arranged on a body of an object to enable an object-tracking system to track the body based on images of the plurality of light sources.

In another example, an apparatus for enabling tracking of an object is provided. The apparatus includes: at least one memory and at least one processor (e.g., configured in circuitry) coupled to the at least one memory. The at least one processor configured to: control a plurality of light sources arranged on a body of an object to enable an object-tracking system to track the body based on images of the plurality of light sources.

In another example, a non-transitory computer-readable medium is provided that has stored thereon instructions that, when executed by one or more processors, cause the one or more processors to: control a plurality of light sources arranged on a body of an object to enable an object-tracking system to track the body based on images of the plurality of light sources.

In another example, an apparatus for enabling tracking of an object is provided. The apparatus includes: means for controlling a plurality of light sources arranged on a body of an object to enable an object-tracking system to track the body based on images of the plurality of light sources.

Systems and techniques are described for tracking an object. According to at least one example, an apparatus includes: a camera configured to capture a plurality of images of a tracked object; a communication unit configured to send signals to the tracked object; and at least one processor configured to determine a pose of the tracked object based on the plurality of images of the tracked object.

In another example, a method is provided for tracking an object. The method includes: obtaining a plurality of images of a tracked object; sending signals to the tracked object; and determining a pose of the tracked object based on the plurality of images of the tracked object.

In another example, an apparatus for tracking an object is provided. The apparatus includes: at least one memory and at least one processor (e.g., configured in circuitry) coupled to the at least one memory. The at least one processor configured to: obtain a plurality of images of a tracked object; send signals to the tracked object; and determine a pose of the tracked object based on the plurality of images of the tracked object.

In another example, a non-transitory computer-readable medium is provided that has stored thereon instructions that, when executed by one or more processors, cause the one or more processors to: obtain a plurality of images of a tracked object; send signals to the tracked object; and determine a pose of the tracked object based on the plurality of images of the tracked object.

In another example, an apparatus for tracking an object is provided. The apparatus includes: means for obtaining a plurality of images of a tracked object; means for sending signals to the tracked object; and means for determining a pose of the tracked object based on the plurality of images of the tracked object.

Systems and techniques are described for enabling tracking of an object. According to at least one example, a method is provided for enabling tracking of an object. The method includes: adaptively adjusting a pattern of a plurality of light sources to enable an object-tracking system to track a body on which the plurality of light sources are arranged based on images of the plurality of light sources. Another example method includes: controlling a plurality of light sources to enable an object-tracking system to track a body on which the plurality of light sources are arranged based on images of the plurality of light sources. Another example method includes: controlling a plurality of light sources to enable an object-tracking system to determine a pose of a body on which the plurality of light sources are arranged based on images of the plurality of light sources.

In another example, an apparatus for enabling tracking of an object is provided. The apparatus includes: at least one memory and at least one processor (e.g., configured in circuitry) coupled to the at least one memory. The at least one processor configured to: adaptively adjust a pattern of a plurality of light sources to enable an object-tracking system to track a body on which the plurality of light sources are arranged based on images of the plurality of light sources. Another example apparatus includes at least one memory and at least one processor (e.g., configured in circuitry) coupled to the at least one memory. The at least one processor configured to: control a plurality of light sources to enable an object-tracking system to track a body on which the plurality of light sources are arranged based on images of the plurality of light sources. Another example apparatus includes at least one memory and at least one processor (e.g., configured in circuitry) coupled to the at least one memory. The at least one processor configured to: control a plurality of light sources to enable an object-tracking system to determine a pose of a body on which the plurality of light sources are arranged based on images of the plurality of light sources.

Another example apparatus includes a body comprising a handle to be held in a hand of a user; a plurality of light sources arranged on the body; and at least one processor configured to adaptively adjust a pattern of the plurality of light sources to enable an object-tracking system to track the body based on images of the plurality of light sources. Another example apparatus includes a body comprising a handle to be held in a hand of a user; a plurality of light sources arranged on the body; and at least one processor configured to control the plurality of light sources to enable an object-tracking system to track the body based on images of the plurality of light sources. Another example apparatus includes a body comprising a handle to be held in a hand of a user; a plurality of light sources arranged on the body; and at least one processor configured to control the plurality of light sources to enable an object-tracking system to determine a pose of the body based on images of the plurality of light sources.

In another example, a non-transitory computer-readable medium is provided that has stored thereon instructions that, when executed by one or more processors, cause the one or more processors to: adaptively adjust a pattern of a plurality of light sources to enable an object-tracking system to track a body on which the plurality of light sources are arranged based on images of the plurality of light sources. Another example non-transitory computer-readable medium is provided that has stored thereon instructions that, when executed by one or more processors, cause the one or more processors to: control a plurality of light sources to enable an object-tracking system to track a body on which the plurality of light sources are arranged based on images of the plurality of light sources. Another example non-transitory computer-readable medium is provided that has stored thereon instructions that, when executed by one or more processors, cause the one or more processors to: control a plurality of light sources to enable an object-tracking system to determine a pose of a body on which the plurality of light sources are arranged based on images of the plurality of light sources.

In another example, an apparatus for enabling tracking of an object is provided. The apparatus includes: means for adaptively adjusting a pattern of a plurality of light sources to enable an object-tracking system to track a body on which the plurality of light sources are arranged based on images of the plurality of light sources. Another example apparatus includes means for controlling a plurality of light sources to enable an object-tracking system to track a body on which the plurality of light sources are arranged based on images of the plurality of light sources. Another example apparatus includes means for controlling a plurality of light sources to enable an object-tracking system to determine a pose of a body on which the plurality of light sources are arranged based on images of the plurality of light sources.

Systems and techniques are described for tracking an object. According to at least one example, a method is provided for tracking an object. The method includes: capturing a plurality of images of a tracked object; communicating with the tracked object; and tracking the tracked object based on the plurality of images of the tracked object. Another example method includes: capturing a plurality of images of a tracked object; communicating with the tracked object; and tracking the tracked object based on the plurality of images of the tracked object.

In another example, an apparatus for tracking an object is provided. The apparatus includes: at least one memory and at least one processor (e.g., configured in circuitry) coupled to the at least one memory. The at least one processor configured to: capture a plurality of images of a tracked object; communicate with the tracked object; and determine a pose of the tracked object based on the plurality of images of the tracked object. Another example apparatus includes at least one memory and at least one processor (e.g., configured in circuitry) coupled to the at least one memory. The at least one processor configured to: capture a plurality of images of a tracked object; communicate with the tracked object; and track the tracked object based on the plurality of images of the tracked object.

Another example apparatus includes a camera configured to capture a plurality of images of a tracked object; a communication unit configured to communicate with the tracked object; and at least one processor configured to track the tracked object based on the plurality of images of the tracked object. Another example apparatus includes a camera configured to capture a plurality of images of a tracked object; a communication unit configured to communicate with the tracked object; and at least one processor configured to determine a pose of the tracked object based on the plurality of images of the tracked object.

In another example, a non-transitory computer-readable medium is provided that has stored thereon instructions that, when executed by one or more processors, cause the one or more processors to: capture a plurality of images of a tracked object; communicate with the tracked object; and determine a pose of the tracked object based on the plurality of images of the tracked object. Another example non-transitory computer-readable medium is provided that has stored thereon instructions that, when executed by one or more processors, cause the one or more processors to: capture a plurality of images of a tracked object; communicate with the tracked object; and track the tracked object based on the plurality of images of the tracked object.

In another example, an apparatus for tracking an object is provided. The apparatus includes: means for capturing a plurality of images of a tracked object; means for communicating with the tracked object; and means for tracking the tracked object based on the plurality of images of the tracked object. Another example apparatus includes means for capturing a plurality of images of a tracked object; means for communicating with the tracked object; and means for tracking the tracked object based on the plurality of images of the tracked object.

In some aspects, one or more of the apparatuses described herein is, can be part of, or can include an extended reality (XR) device (e.g., a virtual reality (VR) device, an augmented reality (AR) device, or a mixed reality (MR) device), a mobile device (e.g., a mobile telephone or so-called “smart phone”, a tablet computer, or other type of mobile device), a smart or connected device (e.g., an Internet-of-Things (IoT) device), a wearable device, a personal computer, a laptop computer, a video server, a television (e.g., a network-connected television), a robotics device or system, a vehicle (or a computing device or system of a vehicle), or other device. In some aspects, each apparatus can include an image sensor (e.g., a camera) or multiple image sensors (e.g., multiple cameras) for capturing one or more images. In some aspects, each apparatus can include one or more displays for displaying one or more images, notifications, and/or other displayable data. In some aspects, each apparatus can include one or more speakers, one or more light-emitting devices, and/or one or more microphones. In some aspects, each apparatus can include one or more sensors. In some cases, the one or more sensors can be used for determining a location of the apparatuses, a state of the apparatuses (e.g., a tracking state, an operating state, a temperature, a humidity level, and/or other state), and/or for other purposes.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

Illustrative examples of the present application are described in detail below with reference to the following figures:

FIG. 1 is a diagram illustrating a conventional hand-held controller including a number of light emitting diodes arranged on a tracking ring protruding from a handle of handheld controller.

FIG. 2A is a diagram illustrating an example handheld controller including a number of light sources arranged on a body of handheld controller, according to various aspects of the present disclosure.

FIG. 2B is a diagram illustrating handheld controller being held by a hand of a user, according to various aspects of the present disclosure.

FIG. 3A is a diagram illustrating an example system including a handheld controller and a tracking system, according to various aspects of the present disclosure.

FIG. 3B is a block diagram illustrating example elements of handheld controller and tracking system of system, according to various aspects of the present disclosure.

FIG. 4 is a diagram illustrating a conventional design paradigm and a design paradigm according to various aspects of the present disclosure.

FIG. 5 is a diagram illustrating two groups of illuminated LEDs and a representation of how those groups of LEDs may be observed in an image captured from a distant camera, according to various aspects of the present disclosure.

FIG. 6 is a diagram illustrating two groups of illuminated LEDs and a representation of how those groups of LEDs may be observed in an image captured by a camera, according to various aspects of the present disclosure.

FIG. 7 is a flow diagram illustrating operations of a handheld controller and a tracking system, according to various aspects of the present disclosure.

FIG. 8 is a hybrid block diagram/flowchart illustrating a system and various operations for tracking a handheld controller, according to various aspects of the present disclosure.

FIG. 9 is a hybrid block diagram/flowchart illustrating a system and various operations for tracking a handheld controller, according to various aspects of the present disclosure.

FIG. 10 is a hybrid block diagram/flowchart illustrating a system and various operations for tracking a handheld controller, according to various aspects of the present disclosure.

FIG. 11 is a diagram illustrating an example of an image including a keypoint according to various aspects of the present disclosure.

FIG. 12 is a diagram illustrating a process for determining keypoints, according to various aspects of the present disclosure.

FIG. 13 is a diagram illustrating the training stage of training the encoder and decoder of FIG. 12, according to various aspects of the present disclosure.

FIG. 14A is a flow diagram illustrating an example process for improving tracking of a human-machine-interface (HMI) device, in accordance with aspects of the present disclosure.

FIG. 14B is a flow diagram illustrating another example process for improving tracking of a human-machine-interface (HMI) device, in accordance with aspects of the present disclosure.

FIG. 15 is a flow diagram illustrating an example process for enabling tracking of an object, in accordance with aspects of the present disclosure.

FIG. 16 is a flow diagram illustrating an example process for tracking an object, in accordance with aspects of the present disclosure.

FIG. 17 is a diagram illustrating an example of a deep learning neural network that can be used to implement a perception module and/or one or more validation modules, according to some aspects of the disclosed technology.

FIG. 18 is a diagram illustrating an example of a convolutional neural network (CNN), according to various aspects of the present disclosure.

FIG. 19 is a diagram illustrating an example computing-device architecture of an example computing device which can implement the various techniques described herein.

### DETAILED DESCRIPTION

Certain aspects of this disclosure are provided below. Some of these aspects may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the exemplary aspects will provide those skilled in the art with an enabling description for implementing an exemplary aspect. It should be understood that various changes may be made in the function and arrangement of elements without departing from the spirit and scope of the application as set forth in the appended claims.

The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage, or mode of operation.

Object detection and tracking can be used to detect an object and track the object over time. For example, an image of an object can be obtained and object detection can be performed on the image to detect the object in the image. In some cases, the detected object can be classified into a category of object. Further, a bounding box can be generated to identify a position of the object in the image. Various types of systems can be used for object detection, including neural network-based object detectors. The position of the object in images can be tracked through a series of images. In some cases, tracking the object can include determining a pose of the object relative to a camera which captured the image of the object and/or relative to prior positions of the object. In the present disclosure, the term “pose” may refer to a position and orientation. Poses may be determined according to six degrees of freedom (6DoF) including three translational degrees of freedom (DoF) (e.g,. x, y, and z dimensions) and three rotational degrees of freedom (e.g., roll, pitch, and yaw).

A handheld controller can be used as a human-machine-interface (HMI) device. For example, an object-tracking system may detect and track the handheld controller and a user can interface with a machine by moving and/or rotating the handheld controller. For example, the machine may receive inputs based on how the user moves and/or rotates the handheld controller.

One example of a system that may be interacted with using a handheld controller is an extended reality (XR) device (e.g., a virtual reality (VR) device, an augmented reality (AR) device, or a mixed reality (MR) device). An example of an XR device is a head-mounted display (HMD) device (e.g., in the form of a headset, glasses, etc.) that can be worn by the user. The XR device may include one or more cameras that may capture images of a handheld controller. The user may move and/or rotate the handheld controller. The XR device may include a tracking system that can, using the cameras, track the handheld controller and interpret inputs based on how the user moves and/or rotates the handheld controller. Another example includes a gaming system with a camera mounted above a display.

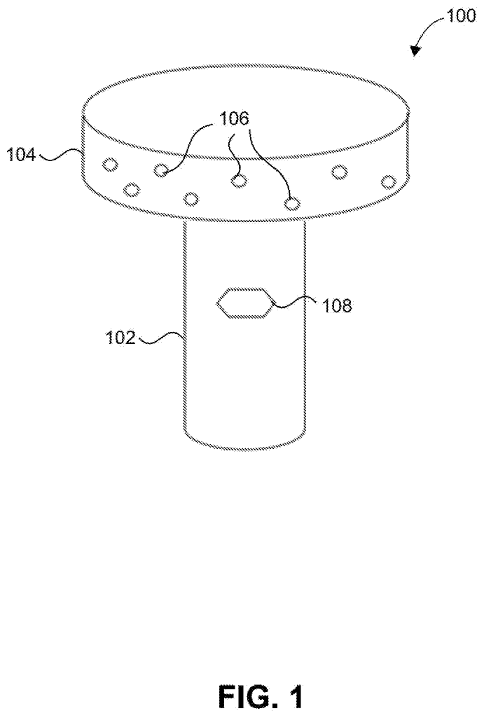

FIG. 1 is a diagram illustrating a conventional hand-held controller 100 including a number of light emitting diodes 106 (LEDs 106) arranged on a tracking ring 104 protruding from a handle 102 of handheld controller 100. Handheld controller 100 includes a button 108 as an example of buttons that may be present on handle 102 of handheld controller 100. A conventional tracking system may rely on images of LEDs 106 on tracking ring 104 to localize and track handheld controller 100. Tracking ring 104 may be bulky, not easy to carry, and inconvenient to use.

To improve the performance of conventional tracking systems, tracking ring 104 protrudes from the outside of handheld controller 100. Because of the requirements of the tracking algorithm, LED tracking rings (e.g., tracking ring 104) must be large enough for the tracking algorithm to accurately track. A large tracking ring affects portability, for example, a controller with a large tracking right may be difficult to put in the pocket and/or to carry around.

Further, in order to avoid the LED tracking light ring being blocked from the view of the HMD by the hand (e.g., a hand holding handle 102) (which may cause tracking to fail), the tracking ring usually protrudes outside where a hand would hold the handle. But such a protruding structure is inconvenient to use, and LED tracking ring can easily hit other objects when in use. For example, when both hands are holding the controller, the hands cannot touch each other due to the obstruction of the protruding part of the LED tracking ring.

Systems, apparatuses, methods (also referred to as processes), and computer-readable media (collectively referred to herein as “systems and techniques”) are described herein for improving tracking of an HMI device. For example, the systems and techniques described herein may include an HMI device including a number of light sources. The systems and techniques may control the light sources to improve the ability of a tracking system to track the HMI device. The systems and techniques may control which light sources of the number of light sources are illuminated, a timing of illuminating the number of light sources, an intensity of illuminating the number of light sources, and/or wavelengths of light produced by the number of light sources (e.g., a color of the light).

By controlling the light sources, the systems and techniques may improve the ability of a tracking system (e.g., of an HMD) to track the HMI device. For example, the tracking system may be more quickly and/or accurately able to determine a position of the HMI device based on the systems and techniques control of the illumination. The systems and techniques may adaptively adjust LED patterns to improve tracking performance in a variety of usage scenarios.

For example, the systems and techniques may improve tracking of controllers that are distant from cameras of the tracking system (e.g., using a sparse illumination mode). As another example, systems and techniques may decrease false positive rate of controller detection (e.g., using a verification mode). As another example, the systems and techniques may decrease controller power consumption (e.g., using an energy-saving mode).

Additionally or alternatively, the systems and techniques include improvements to techniques used to track controllers. For example, the systems and techniques may include determining image features, based on images of a controller, and tracking the image features across a number of images. The image features may be related to the controller, for example, the image features may be based on representations of the controller in the images. Additionally or alternatively, the image features may be related to a hand holding the controller, for example, the image features may be based on representations of a hand holding the controller in the images. The systems and techniques may track the pose of the controller based on the tracked features based on the relation between the image features and the controller. The systems and techniques may be more stable (e.g., allowing the controller to be tracked more consistently) in corner cases (e.g., in which few of the light sources of the controller are visible to the camera of the tracking system) because the systems and techniques may use both a long frame and a short frame to track the controller. For example, the systems and techniques may determine images features using long frames and track the image features based on the long frames.

Based on the improved ability of tracking systems to track the HMI device, some HMI devices, according to various aspects of the application, may exclude a tracking ring and include light sources on a body of the HMI device (e.g., not protruding radially from the handle of the HMI device).

Various aspects of the application will be described with respect to the figures below.

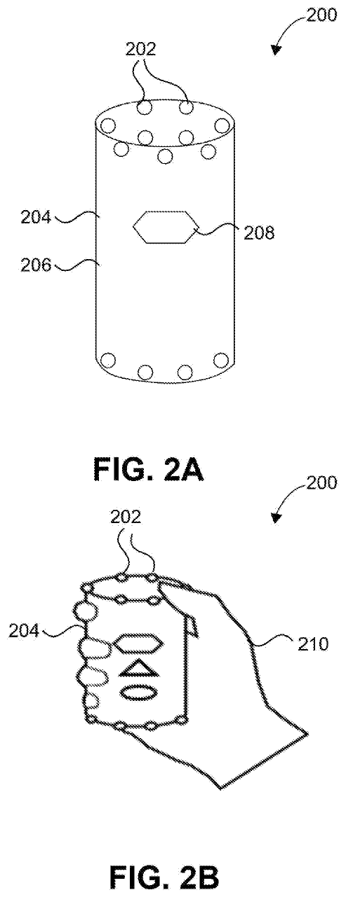

FIG. 2A is a diagram illustrating an example handheld controller 200 including a number of light sources 202 arranged on a body 204 of handheld controller 200, according to various aspects of the present disclosure. In contrast to handheld controller 100 of FIG. 1, light sources 202 are not arranged on a tracking ring 104 protruding from a handle 102. Rather, light sources 202 are arranged on body 204 (e.g., not radially protruding from handle 206 of body 204). Handheld controller 200 includes a button 208 as an example of buttons that may be present on body 204 of handheld controller 200. FIG. 2B is a diagram illustrating handheld controller 200 being held by a hand 210 of a user, according to various aspects of the present disclosure. Handheld controller 200 may be sized such that at least some of light sources 202 are visible when body 204 is held by hand 210.

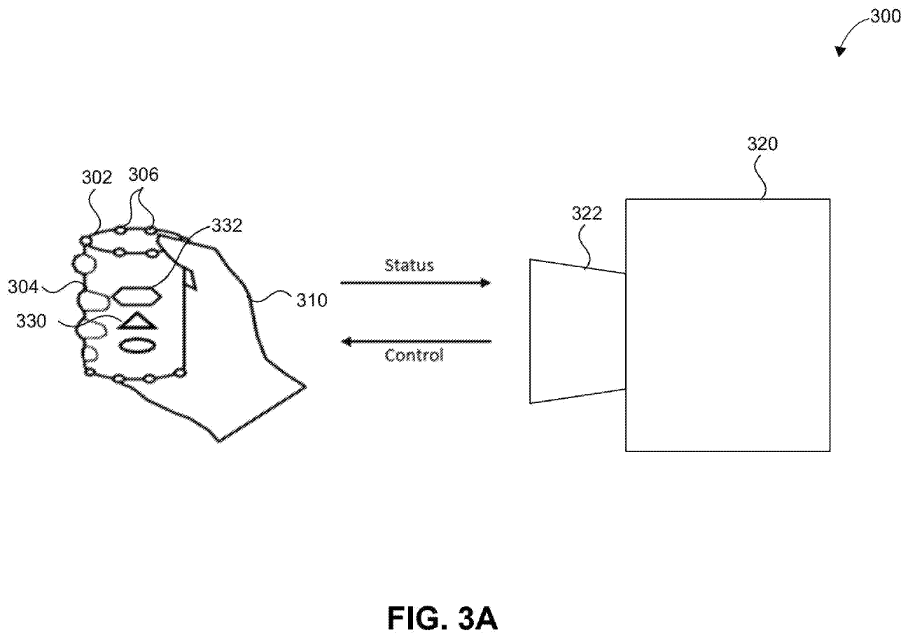

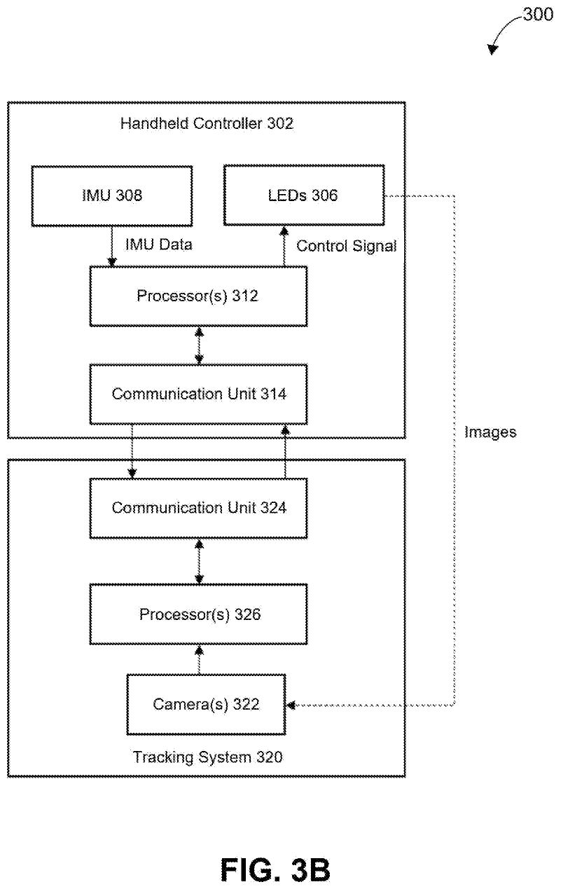

FIG. 3A is a diagram illustrating an example system 300 including a handheld controller 302 and a tracking system 320, according to various aspects of the present disclosure. FIG. 3B is a block diagram illustrating example elements of handheld controller 302 and tracking system 320 of system 300, according to various aspects of the present disclosure. In some cases, the tracking system 320 can be part of or include an XR device (e.g., an HMD).

Handheld controller 302 includes light-emitting diodes (LEDs) 306 on body 304 of handheld controller 302. LEDs 306 may emit visible light (of any color), near infrared light, and/or infrared light. LEDs 306 may include groups of LEDs (e.g., each group including a red LED, a green LED and a blue LED such that each group of LEDs may vary wavelengths of light emitted). LEDs 306 may be included on handheld controller 302 to enable tracking system 320 to track handheld controller 302. Additionally, tracking system 320 may include one or more buttons 332 and/or hand sensors 330 on body 304 of handheld controller 302.Handheld controller 302 includes at least one processor (e.g., processor 312) and a communication unit 314. Handheld controller 302 may include an inertial measurement unit (IMU) 308 that may generate movement data indicative of movement of handheld controller 302.

Tracking system 320 includes a camera 322 which may capture images of handheld controller 302 (particularly of LEDs 306 of handheld controller 302) and/or of a hand holding the handheld controller 302. In some aspects, camera 322 may capture long-exposure images and/or short-exposure images. For example, camera 322 may capture short-exposure images of handheld controller 302. In the short-exposure images, LEDs 306 may be visible based on the brightness of LEDs 306. Other portions of the short-exposure images (e.g., a background) may be dark in the short-exposure images, for example based on the short exposure duration. Additionally, camera 322 may capture long-exposure images. A hand holding handheld controller 302 and/or a surface of handheld controller 302 may be visible in long-exposure images of handheld controller 302. For example, aspects of handheld controller 302 such as buttons (e.g., such as button 208 of FIG. 2), button collars, logos, and/or other surface features may be visible in long-exposure images of handheld controller 302.

Tracking system 320 includes at least one processor (e.g., processor 326). Tracking system 320, using the processor 326, may track handheld controller 302 based on the images of handheld controller 302, the hand, and/or LEDs 306 captured by camera 322. Tracking system 320 may further include a communication unit 324, with which tracking system 320 may communicate with handheld controller 302 (via a communication unit 314 of handheld controller 302). For example, handheld controller 302 may communicate status message and/or movement data (e.g., based on measurements from an inertial measurement unit (IMU 308)) to tracking system 320. Tracking system 320 may communicate control messages (e.g., instructing handheld controller 302 which LEDs 306 to illuminate, instructing handheld controller 302 regarding a timing for illuminating LEDs 306, and/or instructing handheld controller 302 to illuminate LEDs 306 according to a mode of operation, such as verification mode, sparse mode, energy-saving mode, or default mode).

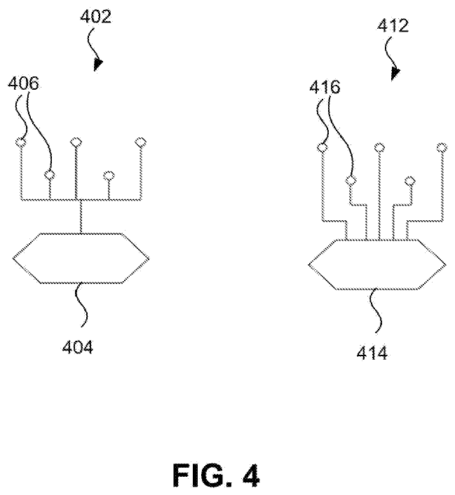

According to various aspects of the present disclosure, handheld controller 302 (or at least one processor of handheld controller 302 (e.g., processor 312)) may control LEDs 306 to enable handheld controller 302 to track handheld controller 302. Handheld controller 302 may independently control each of LEDs 306. For example, handheld controller 302 may control each of LEDs 306 separately (e.g., using separate control or power signals). For example, FIG. 4 is a diagram illustrating a conventional design paradigm 402 in which all LEDs 406 are commonly controlled by a controller (or driver) 404 (e.g., based on all of LEDs 406 being part of the same circuit and/or connected to a common bus). FIG. 4 also illustrates a design paradigm 412, according to various aspects of the present disclosure. According to design paradigm 412, each of LEDs 416 are independently controllable. For example, each of LEDs 416 is independently connected to controller (or driver) 414. In this way, controller (or driver) 414 is capable of causing each of LEDs 416 to illuminate independent of the others of LEDs 416.

Returning to FIG. 3A and FIG. 3B, handheld controller 302 (or processor 312) may control which LEDs 306 are illuminated, a timing of illuminating LEDs 306, an intensity of illuminating LEDs 306, and/or wavelengths of light produced by LEDs 306. For example, handheld controller 302 may cause a group of LEDs 306 to be illuminated. The group may include fewer than all of LEDs 306. In some cases, the group may form a pattern, e.g., a pattern of illuminated LEDs 306 that may be detectable by tracking system 320.

In some case, which of illuminated LEDs 306 are illuminated may be based on a distance between handheld controller 302 and tracking system 320. For example, handheld controller 302 may operate in a “sparse mode.” For example, if controller 302 is distant from tracking system 320 (e.g., 5 meters or more), it may be difficult for tracking system 320 to distinguish LEDs 306. To address this, handheld controller 302 may determine to illuminate LEDs 306 based on a distance between handheld controller 302 and tracking system 320. For example, if handheld controller 302 is less than a threshold distance from tracking system 320, handheld controller 302 may illuminate a first group of LEDs 306. If handheld controller 302 is greater than the threshold distance from tracking system 320, handheld controller 302 may illuminate a second group of LEDs 306. The second group of LEDs 306 may include fewer LEDs 306 than the first group. Additionally or alternatively, the second group of LEDs 306 may be more sparsely arranged than the first group. In this way, different LED spots can be distinguished easily at a long distance.

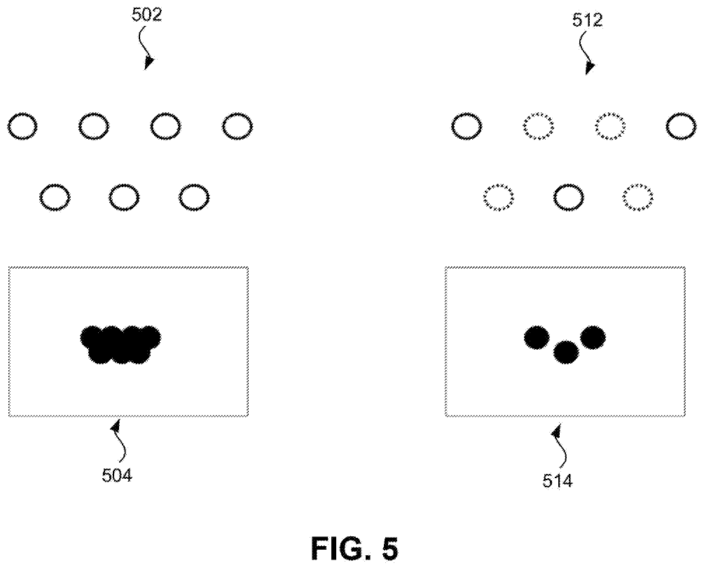

FIG. 5 is a diagram illustrating two groups of illuminated LEDs and a representation of how those groups of LEDs may be observed in an image captured from a distant camera, according to various aspects of the present disclosure. In particular, group 502 includes seven LEDs, all illuminated. Representation 504 is a representation of how the seven illuminated LEDs of group 502 may appear in an image captured by a camera that is a distance (e.g., 5 meters or more) away from the LEDs. Group 512 includes seven LEDs, three illuminated and four not illuminated. Representation 514 is a representation of how the seven illuminated LEDs of group 512 may appear in an image captured by a camera that is a distance (e.g., 5 meters or more) away from the LEDs. It may be easier to distinguish LEDs, or the pattern of the LEDS, of group 512 than to distinguish the LEDS, or the pattern of the LEDs of group 502.

A handheld controller 302 without a tracking ring may have a denser arrangement of LEDs 306 than a controller with a tracking ring. For example, the distance between LEDs 306 of FIG. 3A may be smaller than the distance between LEDs 106 of FIG. 1. At a long distance, it may be difficult to distinguish a single LED because the distance between multiple LED lights may too close to one another. Handheld controller 302 may not illuminate all the LEDs 306, but illuminate LEDs 306 spaced at a suitable distance apart from one another, for example, as illustrated by group 512 of FIG. 5. In this way, different LEDs can be distinguished from images captured from a distance. In sparse mode, as shown in FIG. 5, the sparse illumination pattern (e.g., group 512) may be detected and tracked. Handheld controller 302 may switch to sparse mode when handheld controller 302 is farther than a predefined distance threshold from tracking system 320. In some cases, tracking system 320 may instruct handheld controller 302 to switch to sparse mode.

Returning to FIG. 3A and FIG. 3B, tracking system 320, based on determining a pose of handheld controller 302, may determine a distance between handheld controller 302 and handheld controller 302. Tracking system 320 may communicate the distance between handheld controller 302 and tracking system 320 to handheld controller 302. When the distance is beyond the threshold, handheld controller 302 may determine to illuminate a group of LEDs 306, such as group 512. Additionally or alternatively, tracking system 320 may instruct handheld controller 302 to enter a sparse mode or to illuminate the group of LEDs 306, such as group 512. Additionally or alternatively, handheld controller 302 may determine a distance between handheld controller 302 and tracking system 320 (e.g., based on a signal strength of communications between tracking system 320 and handheld controller 302). In such cases, when the distance is beyond the threshold, handheld controller 302 may determine to illuminate the group of LEDs 306, such as group 512.

As another example of controlling which LEDs 306 are illuminated in some case, the group of illuminated LEDs 306 may be based on a pose of handheld controller 302 (e.g., based on which of LEDs 306 are visible to camera 322). For example, handheld controller 302 may communicate a pose of handheld controller 302 relative to camera 322 to handheld controller 302. Additionally or alternatively, handheld controller 302 may determine (or estimate) a pose of handheld controller 302 relative to camera 322 based on a signal from tracking system 320 and/or based on tracking movement data from IMU 308. For example, handheld controller 302 may include a directional antenna (e.g., in communication unit 314) and may determine a direction between handheld controller 302 and tracking system 320 based on a signal received at the direction antenna. In any case, handheld controller 302 may determine which of LEDs 306 to illuminate based on the pose (e.g., based on which of LEDs 306 are visible to camera 322). By not illuminating LEDs 306 that are not visible to camera 322, handheld controller 302 may conserve power. Additionally or alternatively, the group of illuminated LEDs 306 may be based on a pose of handheld controller 302 relative to hand 310. For example, tracking system 320 may detect hand 310 in images captured by camera 322. Tracking system 320 may provide handheld controller 302 with information regarding a position of hand 310 or a position of handheld controller 302 (or LEDs 306) relative to hand 310. Additionally or alternatively, handheld controller 302 may include a hand sensor 330 that processor 312 may use to determine a position of hand 310 relative to LEDs 306 of handheld controller 302. Handheld controller 302 may determine to illuminate the group of LEDs 306 based on the pose of handheld controller 302 relative to hand 310 (e.g., based on which of LEDs 306 are visible to camera 322 despite hand 310).

As another example of controlling which LEDs 306 are illuminated, handheld controller 302 may control which of LEDs 306 are illuminated to allow tracking system 320 to verify handheld controller 302. For example, handheld controller 302 and/or tracking system 320 may operate in a verification mode. In some cases, false detections may be an issue (e.g., tracking system 320 may misinterpret other light sources, such as LEDs, in images captured by camera 322 as LEDs 306). For example, light spots in the background that are similar to the controller may be falsely detected as a controller. As another example, there may be other controllers in images captured by camera 322. The other controllers may include LEDs. Tracking system 320 may, or may not, intend to track the other controllers. For example, in some cases, tracking system 320 may interface with a number of controllers, for instance for multi-player gaming. In other cases, the other controllers may be coincidental in the scene. For example, the other controller may be associated with another tracking system. To verify handheld controller 302, and/or to decrease false detections, handheld controller 302 may vary which of LEDs 306 are illuminated to allow tracking system 320 to verify that LEDs 306 are LEDs 306 of handheld controller 302.

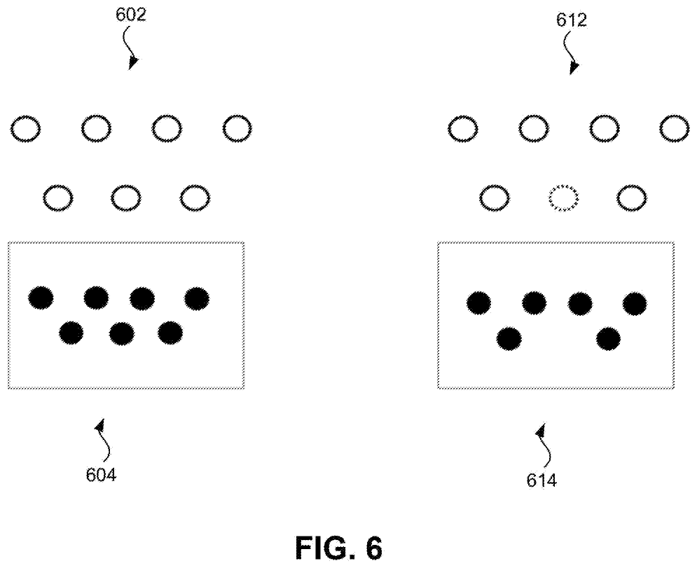

For example, controller may detect LEDs 306 in a first image. The LEDs 306 illuminated in the first image may be a first group and may be according to a first pattern. FIG. 6 is a diagram illustrating two groups of illuminated LEDs and a representation of how those groups of LEDs may be observed in an image captured by a camera, according to various aspects of the present disclosure. In particular, group 602 includes seven LEDs, all illuminated. Representation 604 is a representation of how the seven illuminated LEDs of group 602 may appear in an image captured by a camera. Group 612 includes seven LEDs, six illuminated and one not illuminated. Representation 614 is a representation of how the seven illuminated LEDs of group 612 may appear in an image captured by a camera. Representation 604 may be visually distinct from representation 614 such that tracking system 320 may differentiate between representation 604 and representation 614.

Returning to FIG. 3A and FIG. 3B, tracking system 320 may communicate to handheld controller 302 that tracking system 320 is verifying handheld controller 302. In response, handheld controller 302 may change which of LEDs 306 are illuminated such that a second group of LEDs 306 is illuminated. The second group may be different than the first group and may be according to a second pattern that may be different from the first pattern. For example, tracking system 320 may send a signal to handheld controller 302 indicating that tracking system 320 is verifying handheld controller 302. In response, handheld controller 302 may switch from illuminating a group 602 of LEDs 306 to illuminating a group 612 of LEDs 306.

Tracking system 320 may capture a second images and may determine if a group of LEDs 306 detected in the first image changed after tracking system 320 communicated to handheld controller 302 that tracking system 320 is verifying handheld controller 302. If the pattern of LEDs 306 changed after tracking system 320 communicated that it was verifying handheld controller 302, tracking system 320 may verify handheld controller 302 (e.g., by determining that handheld controller 302 is a valid handheld controller 302). If the pattern did not change, tracking system 320 may determine that the detected LEDs were a false detection. In some cases, the first and/or second patterns may be agreed upon between handheld controller 302 and tracking system 320. For example, the first and/or second patterns may be pre-determined. In other cases, one of handheld controller 302 or tracking system 320 may communicate the pattern to the other. For example, tracking system 320 may instruct handheld controller 302 to illuminate group 612 to enable tracking system 320 to verify handheld controller 302. As another example, handheld controller 302 may inform tracking system 320 that handheld controller 302 is illuminating group 612 to enable tracking system 320 to verify handheld controller 302.

In some cases, handheld controller 302 may have a default pattern (which may be referred to as a “normal pattern”) for illuminating LEDs 306. The default pattern may include illuminating all of LEDs 306. Handheld controller 302 may, by default illuminate LEDs 306 according to the default pattern. In some cases, to be detectable, handheld controller 302 may illuminate LEDs 306 according to the default pattern. In some cases, when handheld controller 302 is not distant from tracking system 320 (e.g., as determined based on the threshold), handheld controller 302 may illuminate LEDs 306 according to the default pattern. In some cases, after tracking system 320 verifies handheld controller 302, handheld controller 302 may illuminate LEDs 306 according to the default pattern.

In some cases, handheld controller 302 may include an inertial measurement units 308 (IMU 308). IMU 308 may measure movement and/or rotation of handheld controller 302. In such cases, handheld controller 302 may also include a communication unit 314, which handheld controller 302 may use to communicate movement information (e.g., information indicative of the measured movements and/or rotations of handheld controller 302) to tracking system 320. In such cases, handheld controller 302 may include at least one processor (e.g., processor 312) to generate the movement information based on the measurements of IMU 308. Tracking system 320 may use the movement information (in addition to the images) to track handheld controller 302.

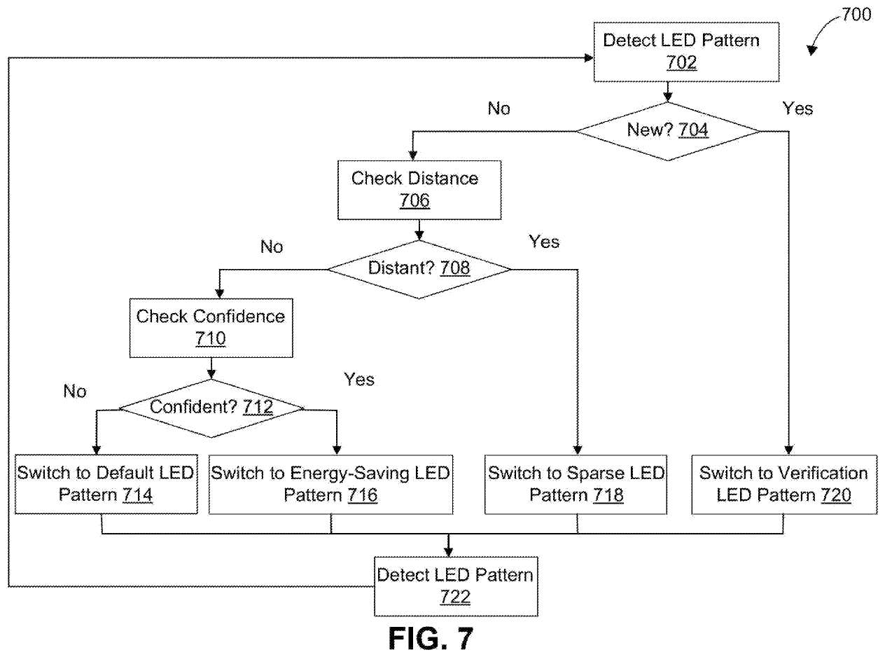

FIG. 7 is a flow diagram 700 illustrating operations of a handheld controller and a tracking system, according to various aspects of the present disclosure. The operations of FIG. 7 will be described with relation to system 300 for descriptive purposes.

At block 702, tracking system 320 may detect a pattern of LEDs 306 illuminated by handheld controller 302. Initially, handheld controller 302 may be illuminating LEDs 306 according to a default (or “normal”) pattern. At block 704, tracking system 320 may determine whether this is the first time LEDs 306 have been detected. If this is the first time LEDs 306 have been detected, tracking system 320 may communicate to handheld controller 302 that tracking system 320 is verifying handheld controller 302. In response, at block 720, handheld controller 302 may switch from the default pattern of illuminating LEDs 306 (e.g., as illustrated by group 602 of FIG. 6) to a verification pattern (e.g., as illustrated by group 612 of FIG. 6) (which may be a pre-determined pattern, pattern communicated between handheld controller 302 and tracking system 320, or a different pattern).

Following block 720, tracking system 320 may detect the verification pattern at block 722. Detecting an LED pattern at block 722 may cause a return to block 702. At block 704, tracking system 320 may determine that this is not the first time the LEDs have been detected, so tracking system 320 may proceed to block 706.

At block 706, tracking system 320 may verify handheld controller 302. Further, at block 706, tracking system 320 may send a signal to handheld controller 302 indicating that handheld controller 302 is verified. Based on being verified, handheld controller 302 may return to illuminating LEDs 306 according to the default pattern. Additionally or alternatively, handheld controller 302 may return to illuminating the default pattern after the expiration of a timeout. For example, handheld controller 302 may switch back to the default pattern 1 second after switching to the verification pattern.

At block 706, tracking system 320 (or handheld controller 302) may check whether handheld controller 302 is distant from tracking system 320 (e.g., based on one or more distance thresholds). At block 708, if handheld controller 302 is distant from tracking system 320, tracking system 320 may notify handheld controller 302. Additionally or alternatively, handheld controller 302 may determine that handheld controller 302 is distant from tracking system 320. In either case, at block 718, handheld controller 302 may illuminate LEDs 306 according to a sparse LED pattern (e.g., as illustrated by group 512 of FIG. 5). Following block 718, tracking system 320 may detect handheld controller 302 at block 722 and return to block 702.

If, at block 708, tracking system 320 determines that handheld controller 302 is not distant from tracking system 320, handheld controller 302 may continue illuminating LEDs 306 according to the default pattern (or verification pattern). Further, tracking system 320, or handheld controller 302, may check, at block 710, a confidence of detecting, identifying, and/or tracking various LEDs of LEDs 306 and/or of handheld controller 302. The confidence with which tracking system 320 can detect various LEDs of LEDs 306 may be based, at least in part, on the pose of handheld controller 302 (relative to camera 322 and/or relative to hand 310). For example, tracking system 320 (or handheld controller 302) may determine that tracking system 320 is confidently tracking LEDs 306 and may determine which of LEDs 306 are visible to camera 322. At block 716, if some of LEDs 306 are not visible to camera 322 (e.g., based on the pose of handheld controller 302 relative to camera 322 and/or based on the pose of handheld controller 302 relative to hand 310) handheld controller 302 may cease illuminating those LEDs 306.

Tracking system 320 can continue to track handheld controller 302 even if fewer than all of LEDs 306 are illuminated. Tracking LEDs 306 may be easier than detecting LEDs 306. For example, it may be easier for tracking system 320 to track LEDs 306 from one image to another than it is for tracking system 320 to initially detect LEDs 306 and to determine a pose of handheld controller 302. LEDs 306 located on the back (from the perspective of camera 322 of tracking system 320) of handheld controller 302 may not be captured by camera 322. At block 716, tracking system 320 and/or handheld controller 302 may determine which of LEDs 306 can be turned off according to the real-time pose of the controller handheld controller 302 and handheld controller 302 may turn them off. Turning off such LEDs 306 may not affect the tracking performance, but it may reduce power consumption and increase battery life of handheld controller 302. Handheld controller 302 may switch to energy-saving mode (e.g., illuminating fewer than all of LEDs 306) when handheld controller 302 is tracked and/or when tracking system 320 has a high confidence regarding the successful identification and tracking of LEDs 306. However, if handheld controller 302 is not being successfully tracked, or if tracking system 320 has a low confidence in its identification of LEDs 306, at block 714 handheld controller 302 may continue (or start) to illuminate LEDs 306 according to the default pattern to better enable tracking system 320 to acquire and track handheld controller 302. Following block 716 or block 714, tracking system 320 may detect handheld controller 302 at block 722 and return to block 702.

The above examples are all described with regard to determining which of LEDs 306 are illuminated and which are not. However, as described above, handheld controller 302 may control which of LEDs 306 are illuminated, a timing of illuminating LEDs 306, an intensity of illuminating LEDs 306, and/or wavelengths of light produced by LEDs 306. Accordingly, handheld controller 302 may change a timing of illuminating one or more of LEDs 306 (e.g., to form a verification pattern, a sparse pattern, or an energy-saving pattern). For example, to conserve power (e.g., in energy-saving mode, which may be entered if tracking system 320 is tracking handheld controller 302 and/or is confident of its identification of LEDs 306), handheld controller 302 may alter an intensity of illumination of LEDs 306. For example, handheld controller 302 may supply LEDs 306 with less current which may dim LEDs 306. As another example, handheld controller 302 may alter a timing of illuminating LEDs 306 to dim the intensity of LEDs 306. For example, handheld controller 302 may illuminate LEDs 306 half of the time, effectively dimming the intensity of LEDs 306.

Additionally or alternatively, handheld controller 302 may cause one (or several) of LEDs 306 to blink at a particular rate (e.g., on for 2 millisecond then off for 1 millisecond) to form a verification pattern or a sparse pattern or to conserve power. For example, handheld controller 302 may change an intensity of illuminating one or more of LEDs 306 (e.g., to form a verification pattern, a sparse pattern, or an energy-saving pattern). For example, handheld controller 302 may cause one (or several) of LEDs 306 to be illuminated at 25% intensity and one or more others of LEDs 306 to be illuminated at 75% intensity to form a verification pattern or a sparse pattern or to conserve power. As another example, in verification mode, the verification pattern can be in other styles or other brightness, as long as there is a clear difference between the verification pattern and the normal pattern, and the verification pattern can be tracked. Additionally or alternatively, the systems and techniques may control the brightness of the LED by controlling the duration of the LED's lighting. The longer the duration, the higher the brightness. Additionally or alternatively, the brightness of the LED can also be controlled by controlling the lighting frequency of the LED light, the higher the frequency, the higher the brightness.

Additionally or alternatively, handheld controller 302 may change wavelengths of illumination generated by one or more of LEDs 306 (e.g., to form a verification pattern, a sparse pattern, or an energy-saving pattern). For example, handheld controller 302 may cause one (or several) of LEDs 306 to illuminate at a different wavelength (e.g., having a different color). to form a verification pattern or a sparse pattern or to conserve power.

Additionally or alternatively, handheld controller 302 may cause LEDs 306 to illuminate according to a refresh rate of camera 322 (e.g., an image-capture rate of camera 322). For example, tracking system 320 may communicate the refresh rate of camera 322 to handheld controller 302 (e.g., using processor 326). Handheld controller 302 may control LEDs 306 to illuminate according to (e.g., to match) the refresh rate of camera 322.

In some cases, camera 322 may include an array of cameras. The array of cameras may be collocated or distributed through an environment (e.g., surrounding handheld controller 302). In such cases, handheld controller 302 may determine which of LEDs 306 to illuminate based on a pose of handheld controller 302 relative to all of the cameras.

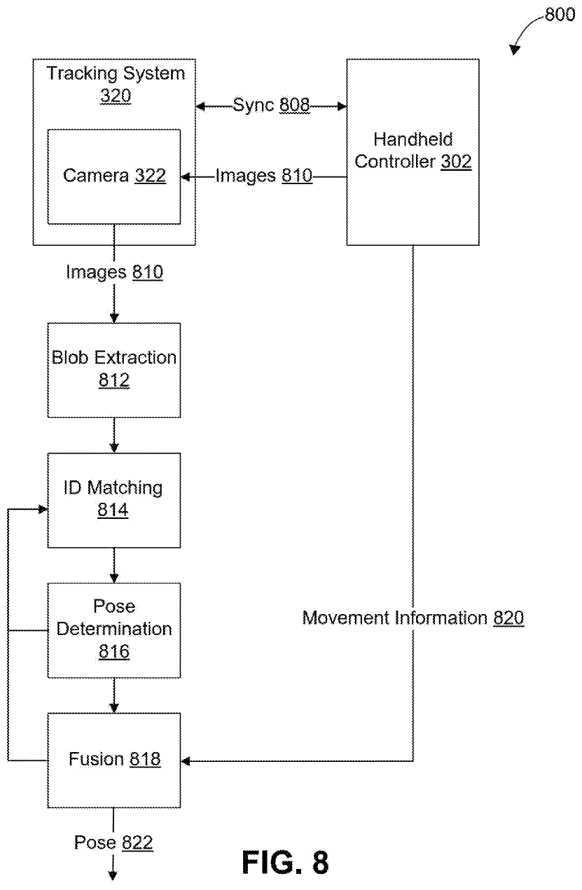

FIG. 8 is a hybrid block diagram/flowchart illustrating a system 800 and various operations for tracking a handheld controller, according to various aspects of the present disclosure. Tracking system 320 may implement one or more of the operations of FIG. 8 (e.g., blob extraction 812, ID matching 814, pose determination 816, and fusion 818).

In some aspects, at sync 808, tracking system 320 may synchronize with handheld controller 302. For example, tracking system 320 may communicate an image-capture rate and/or image-capture times of camera 322. For instance, tracking system 320 may transmit a strobe signal to handheld controller 302 indicating when camera 322 is capturing images. By synchronizing tracking system 320 with handheld controller 302, handheld controller 302 may be able to cause LEDs 306 of handheld controller 302 to be illuminated when camera 322 is capturing images 810 of handheld controller 302.

At blob extraction, tracking system 320 may detect blobs (e.g., groups of LEDs 306). Blobs may appear as representation 504, representation 514, representation 604 or representation 614.

At ID matching, LED blobs are extracted. Then the blobs are sorted to get the matching identifier (ID) of LEDs. In other words tracking system 320 may determine which blobs in images 810 correspond to which LEDs 306 of handheld controller 302. For example, each of LEDs 306 may have an identifier. It may be important for tracking system 320 to differentiate between LEDs 306 while determining a pose of handheld controller 302. At ID matching 814, tracking system 320 may determine which of the detected blobs corresponds to various ones of LEDs 306.

At pose determination 816, tracking system 320 may determine a pose 822 of handheld controller 302. Tracking system 320 may use a perspective-n-point (PnP) algorithm to determine pose 822 of handheld controller 302. Pose 822 may be determined according to six degrees of freedom (6DoF) including three dimensional degrees of freedom (e.g., x, y, and z dimensions) and three rotational degrees of freedom (e.g., roll, pitch, and yaw).

In some cases, handheld controller 302 may provide movement information 820 (e.g., based on an inertial measurement unit (IMU) of handheld controller 302) to tracking system 320. In such cases, at fusion 818, tracking system 320 may fuse pose 822 (e.g., at pose determination 816) may with movement information 820. For example, tracking system 320 may update or revise pose 822 of handheld controller 302 based on acceleration and/or rotation of handheld controller 302, as indicated by the movement information.

In some cases, ID matching 814, pose determination 816, and fusion 818 may involve an iterative process of determining pose 822. For example, ID matching 814 may involve assigning an LED ID to each LED detected in an image of handheld controller 302. The IDs may be assigned based on a matching between the image and a projection of a model of handheld controller 302 into an image plane. Matching the projection of the model may be related to determining pose 822 of handheld controller 302 (e.g., at pose determination 816). For example, the pose of the model that matches the image may be determined as pose 822 of handheld controller 302. Any updates made to pose 822 (e.g., at fusion 818) based on movement information 820 may be propagated back to ID matching 814 and pose determination 816. As another example, ID matching 814, pose determination 816, and fusion 818 may work together to determine pose 822.

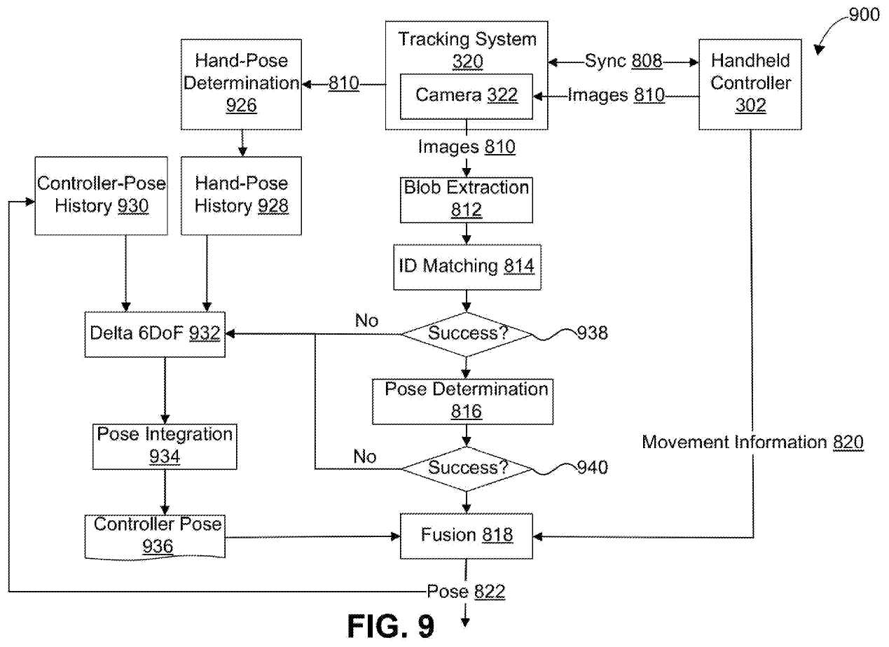

FIG. 9 is a hybrid block diagram/flowchart illustrating a system 900 and various operations for tracking a handheld controller 302, according to various aspects of the present disclosure. Tracking system 320 may implement one or more of the operations of FIG. 9 (e.g., blob extraction 812, ID matching 814, pose determination 816, fusion 818, hand-pose determination 926, delta 6DoF 932, and pose integration 934).

System 900 may include many of the operations of system 800 of FIG. 8. Additionally, in some aspects, at decision block 938, system 900 may check for success of ID matching 814 and at decision block 940, system 900 may check for success of pose determination 816. For example, system 900 may determine whether IDs of LEDs of images 810 were successfully determined (beyond a threshold) and/or whether a pose of handheld controller 302 was successfully determined based on images 810 (beyond a threshold).

If tracking system 320 is able to, at ID matching 814, match LED IDs to LED blobs (detected at blob extraction 812) and to determine the pose of handheld controller 302 at pose determination 816, (e.g., by solving the PnP problem based on images 810), pose determination 816 may determine pose 822. Further, as described above, if handheld controller 302 provides movement information 820 (e.g., based on an inertial measurement unit (IMU) of handheld controller 302) to tracking system 320, then at fusion 818, tracking system 320 may, or may not, refine the pose determined by pose determination 816 based on movement information 820.

However, if tracking system 320 is not able to match (beyond a threshold) LED IDs with LED blobs of 810, or if tracking system 320 is not able to determine pose 822 of handheld controller 302 (beyond a threshold), system 900 may implement hand-pose determination 926, delta DoF 932, and integration 934 to determine controller pose 936. Then tracking system 320 may determine pose 822 based on the best pose information determined by pose determination 816 and controller pose 936. Further, if handheld controller 302 provided movement information 820, tracking system 320 may determine pose 822 based on movement information 820.

In other aspects, system 900 may exclude one or both of decision block 938 and decision block 940 and determine pose 822 based on pose information determined by pose determination 816 and controller pose 936.

At hand-pose determination 926, tracking system 320 may determine (or receive) a hand pose (e.g., information regarding a pose of a hand 310 of the user that is holding handheld controller 302). In some aspects, at hand-pose determination 926, tracking system 320 may determine a pose of a hand holding handheld controller 302. For example, tracking system 320 may implement a hand-pose determination model that may determine the pose of hand 310 based on images of hand 310 capture by camera 322. The hand-pose determination model may be a machine-learning model trained to determine hand poses based on images of hands.

At hand-pose history 928, tracking system 320 may store (or receive) and/or retrieve historical information regarding a pose of hand 310. The historical information may include prior poses of hand 310.

At controller-pose history 930, historical information regarding a pose of handheld controller 302 may be stored and/or retrieved. For example, previously-determined poses 822 may be stored at controller-pose history 930.

At delta 6DoF 932, historical controller pose information and/or historical hand pose information may be used to determine a pose of handheld controller 302.

For example, if few (or none of) LEDs 306 are visible in the images, the result may be that pose determination 816 fails to determine the pose of handheld controller 302 and/or ID matching 814 fails to match the blobs with IDs. In any case, if either ID matching 814 or pose determination 816 fails (for whatever reason) delta 6DoF 932 may use hand-pose history 928 and controller-pose history 930 to determine a delta pose (e.g., a difference between the current pose and a prior pose). Delta 6DoF 932 may solve the energy function below to get the delta 6DoF, T_delta:

E=F(T_delta*T_hand_history,T_controller_history))T_delta=argmin(E)

F can be an l2 loss function (e.g., based on the square of the absolute value of the difference) or an 11 loss function (e.g., the absolute value of the difference). T_denotes a transformation matrix which may include a translation and a rotation.

In the case that the LEDs are not seen but the hand pose T_hand is got, the controller pose can be got from the equation below:

T_controller=T_delta*T_hand

Integration 934 may determine controller pose 936 based on an output of DoF 932 and fusion 818 may determine pose 822 based on an output of pose determination 816, controller pose 936 (whether or not ID matching 814 and pose determination 816 succeeded), and movement information 820 (if movement information 820 is provided).

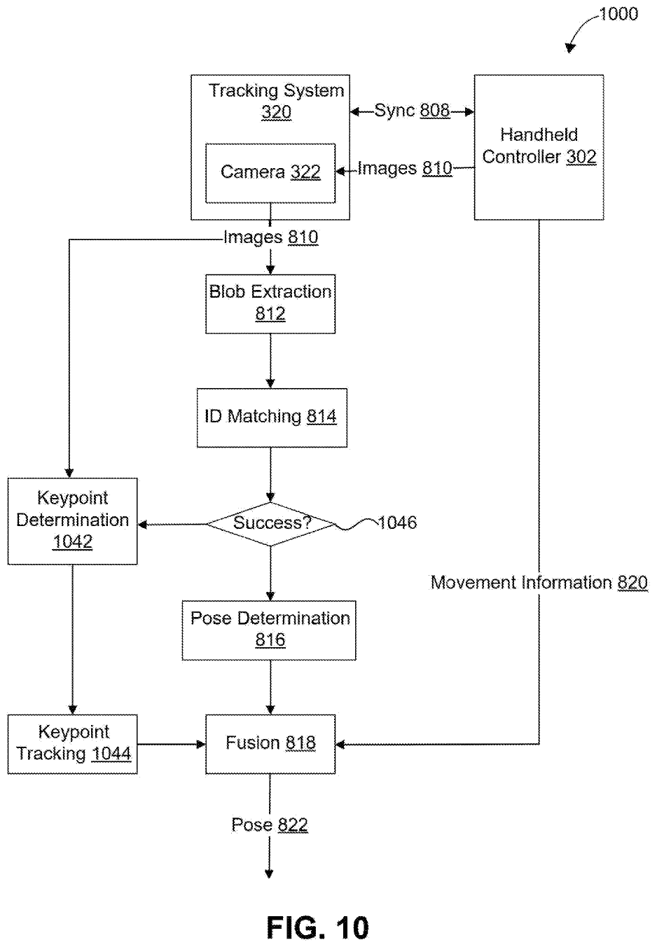

FIG. 10 is a hybrid block diagram/flowchart illustrating a system 1000 and various operations for tracking a handheld controller 302, according to various aspects of the present disclosure. Tracking system 320 may implement one or more of the operations of FIG. 10 (e.g., blob extraction 812, ID matching 814, pose determination 816, fusion 818, keypoint determination 1042, and keypoint tracking 1044).

System 1000 may include many of the operations of system 800 of FIG. 8. Additionally, in some aspects, at decision block 1046, system 1000 may check for success of ID matching 814. For example, system 1000 may determine whether IDs of LEDs of images 810 were successfully determined (beyond a threshold). Additionally, though not illustrated in FIG. 10, system 1000 may check to determine whether pose determination 816 succeeded (beyond a threshold).

If tracking system 320 is able to, at ID matching 814, match LED IDs to LED blobs (detected at blob extraction 812), pose determination 816 may determine a pose. Further, as described above, if handheld controller 302 provides movement information 820 (e.g., based on an inertial measurement unit (IMU) of handheld controller 302) to tracking system 320, then at fusion 818, tracking system 320 may use the pose determined by pose determination 816 with the movement information 820 to determine pose 822.

However, if tracking system 320 is not able to match (beyond a threshold) LED IDs with LED blobs of 810 (and/or if pose determination 816 is unable to determine a pose of handheld controller 302), system 1000 may implement hand-pose keypoint determination 1042 and keypoint tracking 1044 to determine a controller pose. Then, at fusion 818 tracking system 320 may determine pose 822 based on the best pose information determined by pose determination 816 and the controller pose determined at keypoint tracking 1044.

In other aspects, system 1000 may exclude decision block 1046 and determine pose 822 based on pose information determined by pose determination 816 and the controller pose determined at keypoint tracking 1044. In such aspects, fusion 818 may combine pose information from keypoint tracking 1044 and pose information from pose determination 816. Further, if handheld controller 302 provided movement information 820, fusion 818 may determine pose 822 based on movement information 820.

At keypoint determination 1042, tracking system 320 may extract key points of images 810. The keypoints may be image features of images 810. The keypoints may be extracted by a machine-learning model trained to extract image features.

In cases in which LEDs 306 are located on handheld controller 302, fewer than all of LEDs 306 may be visible to camera 322. So, at keypoint determination 1042, a long exposure frame may be used to identify keypoints. The keypoints may be keypoints of a hand 310 holding handheld controller 302 and/or based on handheld controller 302. The keypoints may be used by keypoint tracking 1044 to determine pose of handheld controller 302.

In some aspects, keypoint determination 1042 may precede ID matching 814 and an output of keypoint determination 1042 may be provided to ID matching 814. Keypoint determination 1042 may ensure the blobs get the correct LED ID at ID matching 814.

At keypoint tracking 1044, a pose of handheld controller 302 may be determined based on the keypoints determined at keypoint determination 1042. Additionally or alternatively, at keypoint tracking 1044 keypoints of images 810 may be tracked across images 810.

If ID matching 814 is successful, pose 822 can be determined pose determination 816 based on blobs. If ID matching 814 fails (or if pose determination 816 fails) 1044 may determine a pose of the controller and the pose from keypoint determination 1042 and keypoint tracking 1044 may be used to fused with movement information 820 from IMU data from handheld controller 302. Additionally, a short-exposure frame may be used to help determine pose of handheld controller 302.

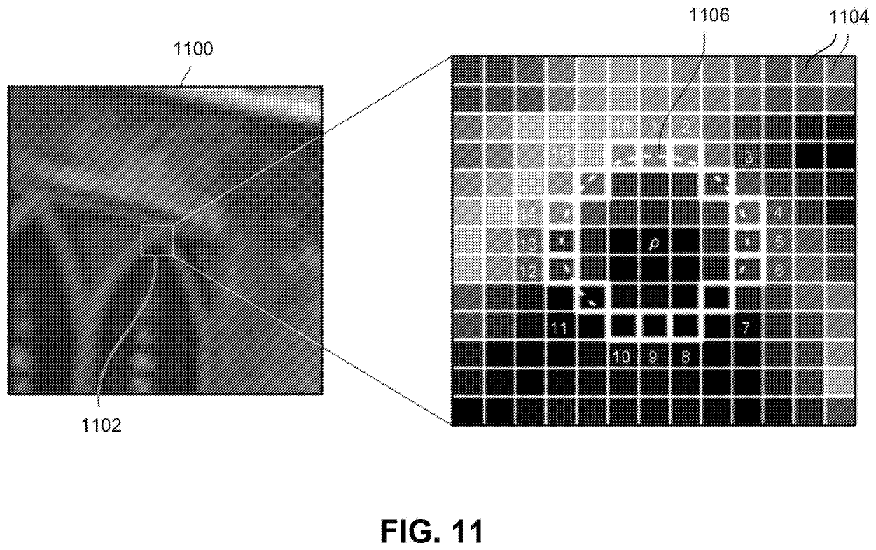

FIG. 11 is a diagram illustrating an example of an image 1100 including a keypoint p according to various aspects of the present disclosure. Keypoint p is surrounded by a window 1102 of pixels 1104 in the image 1100. Keypoint p may be selected such that keypoint p can be matched between images. For example, Keypoint p may be visually distinct in image 1100. Keypoint p may be, as an example, a corner point on an object. In the art a keypoint may be alternatively referred to as a visual feature, a point of interest or a key point. An example keypoint-detection method is described with regard to FIG. 11. In particular, FIG. 11 illustrates the Features from Accelerated Segment Test (FAST) technique (Machine Learning for High-Speed Corner Detection, Edward Rosten & Tom Drummond, ECCV 2006: Computer Vision-ECCV 2006 pp 430-443, Part of the Lecture Notes in Computer Science book series (LNIP, volume 3951)). In the FAST method, a pixel under test (e.g., pixel p) with intensity Ip may be identified as an interest point. A circle 1106 of sixteen pixels (pixels 1-16) around the pixel under test p (e.g., a Bresenham circle of radius 3) may then be identified. The pixel under test p may be considered a keypoint if there exists a set of n contiguous pixels in circle 1106 of sixteen pixels that are all brighter than Ip+t, or all darker than Ip−t, where t is a threshold value and n is configurable. In this example, n may be twelve. For example, the intensity of pixels 1, 5, 9, and 13 of the circle may be compared with Ip. If at least three of the four pixels do not satisfy the threshold criteria, the pixel p is not considered an interest point. As can be seen in FIG. 11, at least three of the four pixels satisfy the threshold criteria. Therefore, all sixteen pixels may be compared to pixel p to determine if twelve contiguous pixels meet the threshold criteria. This process may be repeated for each of pixels 1104 in the image 1100 to identify the corner points corresponding to keypoint p in image 1100.

Although FIG. 11 illustrates a FAST keypoint-identifying method, it should be understood that the present disclosure is applicable to any keypoint-identifying method. Examples of keypoint-identifying methods include speeded-up robust features (SURF), scale-invariant feature transform (SIFT), binary robust independent elementary feature (BRIEF), oriented FAST and rotated BRIEF (ORB), and Harris corner point.

As indicated above, a keypoint p represents a feature of an image 1100 that may be matched between multiple images of a scene (e.g., captured from different viewing angles and/or with different intrinsic camera parameters). For example, various cross-correlation or optical flow methods may match features (keypoints) across multiple images. In some examples, each feature may further include a feature descriptor that assists with the matching process. A feature descriptor may summarize, in vector format (e.g., of constant length) one or more characteristics of pixels 1104 of window 1102. For example, the feature descriptor may correspond to the intensity of pixels 1104 of window 1102. In general, feature descriptors are independent of the positions of keypoint p, robust against image transformations, lighting of the scene, and/or weather of the scene, and scale independently. Thus, keypoints with feature descriptors may be independently re-detected in each image frame and then subjected to a keypoint matching/tracking procedure. For example, the keypoints in two different images with matching descriptors and the smallest distance between them may be considered to be matching keypoints. Examples of feature-descriptor methods may include, but are not limited to, ORB, SURF, and BRIEF.

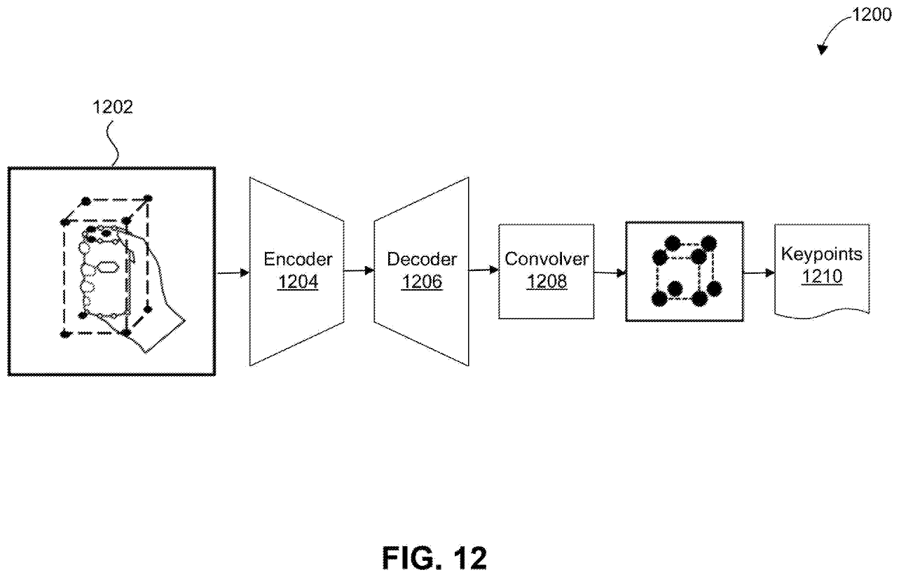

FIG. 12 is a diagram illustrating a system 1200 for determining keypoints 1210, according to various aspects of the present disclosure. The system 1200 includes an encoder 1204, a decoder 1206, and a convolver 1208. In some cases, the system 1200 may be part of the tracking system 320. In some cases, tracking system 320 may use deep learning to determine the keypoints 1210. For example, tracking system 320 may use encoder 1204 and decoder 1206 of the system 1200 to extract features from an image 1202. For example, encoder 1204 may encoder features of image 1202. Decoder 1206 may decode the features into an image space. Convolver 1208 may convolve the features to generate the keypoints 1210.

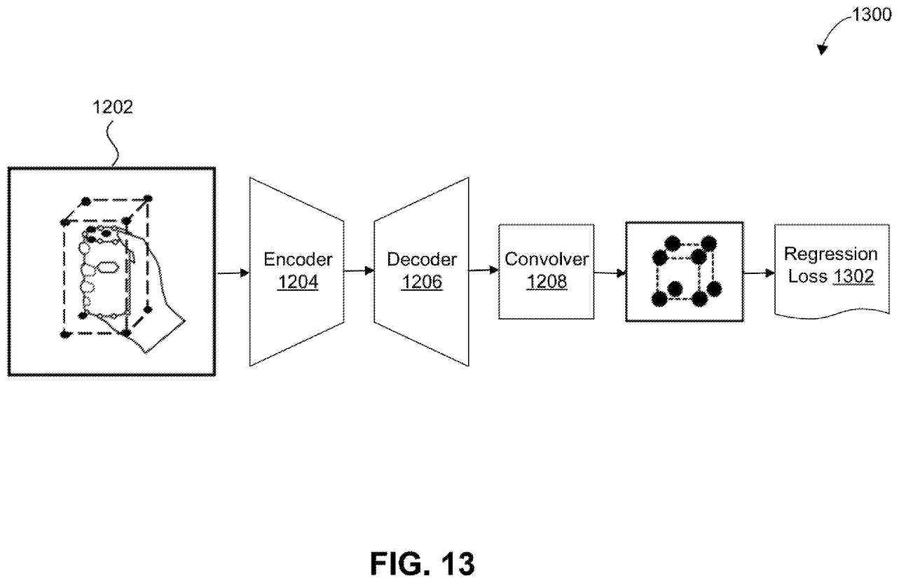

FIG. 13 is a diagram illustrating a training process 1300 for training encoder 1204, decoder 1206, and/or the convolver 1208. FIG. 13 includes determining a regression loss 1302. The regression loss can be used to train encoder 1204, decoder 1206, and/or convolver 1208, for example, through a gradient descent training process which may iteratively decrease regression loss 1302 through successive iterations of the training process.

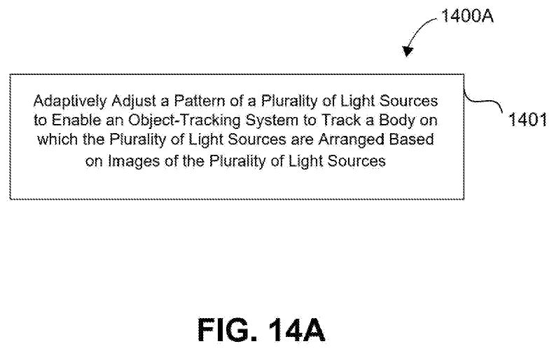

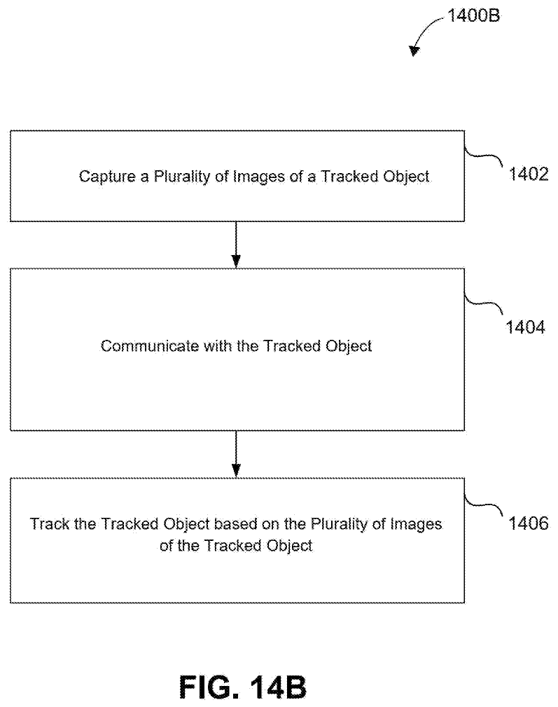

FIG. 14A is a flow diagram illustrating a process 1400A for improving tracking of a human-machine-interface (HMI) device, in accordance with aspects of the present disclosure. One or more operations of process 1400A may be performed by a computing device (or apparatus) or a component (e.g., a chipset, codec, etc.) of the computing device. The computing device may be a vehicle or component or system of a vehicle, a mobile device (e.g., a mobile phone), a network-connected wearable such as a watch, an extended reality (XR) device such as a virtual reality (VR) device or augmented reality (AR) device, a desktop computing device, a tablet computing device, a server computer, a robotic device, and/or any other computing device with the resource capabilities to perform the process 1400A. The one or more operations of process 1400A may be implemented as software components that are executed and run on one or more processors.

At block 1401, a computing device (or one or more components thereof) may adaptively adjust a pattern of a plurality of light sources to enable an object-tracking system to track a body on which the plurality of light sources are arranged based on images of the plurality of light sources. In some aspects, the computing device (or one or more components thereof) may control the plurality of light sources to enable an object-tracking system to track the body based on images of the plurality of light sources. In some aspects, the computing device (or one or more components thereof) may control the plurality of light sources to enable an object-tracking system to determine a pose of the body based on images of the plurality of light sources. For example, processor 312 of handheld controller 302 may adaptively adjust, or control, LEDs 306. The adaptive adjustments, or control, of LEDs 306 may enable tracking system 320 to detect, track, and/or determine a pose of handheld controller 302.

In some aspects, the computing device (or one or more components thereof) may independently control (or adjust) each light source of the plurality of light sources. For example, processor 312 may independently control (or adjust) each of LEDs 306 (e.g., processor 312 may be coupled to LEDs 306 according to design paradigm 412).

In some aspects, the computing device (or one or more components thereof) may control (or adjust) which light sources of the plurality of light sources that are illuminated; a timing of illuminating the plurality of light sources; an intensity of illuminating the plurality of light sources; and/or wavelengths of light produced by the plurality of light sources. For example, processor 312 may control, or adjust, an on/off status of each of LEDs 306, an intensity of each of LEDs 306, a timing of illuminating each of LEDs 306, and/or wavelengths of light produced by LEDs 306.

In some aspects, the light sources of block 1401 may be, or may include, light-emitting diodes (LEDs). In some aspects, the light sources of block 1401 may emit at least one of visible light, near infrared light, or infrared light.

In some aspects, the computing device (or one or more components thereof) may control the plurality of light sources based on a distance between the body and a camera of the object-tracking system. For example, processor 312 may control LEDs 306 based on a distance between handheld controller 302 and tracking system 320. In some aspects, the computing device (or one or more components thereof) may control which light sources of the plurality of light sources are illuminated based on the distance between the body and the camera.

In some aspects, the computing device (or one or more components thereof) may determine whether the body is greater than a threshold distance from the camera of the object-tracking system; and control the plurality of light sources based on whether the body is greater than the threshold distance from the camera. For example, processor 312 may control which of LEDs 306 are illuminated based on whether handheld controller 302 is greater than a threshold distance from tracking system 320. In some aspects, the computing device (or one or more components thereof) may illuminate a first group of the plurality of light sources responsive to the body being less than the threshold distance from the camera; and illuminate a second group of the plurality of light sources responsive to the body being greater than the threshold distance from the camera. For example, processor 312 may illuminate a first group of LEDs 306 (e.g., group 502) based on handheld controller 302 being with a threshold distance from tracking system 320. Further, processor 312 may illuminate a second group of LEDs 306 (e.g., according to group 512) based on handheld controller 302 being greater than the threshold distance from tracking system 320. In some aspects, the second group may include fewer light sources than the first group.

In some aspects, the computing device (or one or more components thereof) may determine a distance between the computing device (or one or more components thereof) and a camera of an object-tracking system. In some aspects, the computing device (or one or more components thereof) may receive a signal from the object-tracking system and determine the distance based on the signal. For example, handheld processor 312 may, using communication unit 314, receive a signal from tracking system 320. In some aspects, the computing device (or one or more components thereof) may determine the distance between the body and the camera based on a strength of the signal. In some aspects, the computing device (or one or more components thereof) may determine the distance between the body and the camera based on a message encoded by the signal.

In some aspects, the computing device (or one or more components thereof) may control the plurality of light sources based on a pose of the body. For example, handheld controller 302 may determine which of LEDs 306 to illuminate based on a pose of tracking system 320. In some aspects, the computing device (or one or more components thereof) may control which light sources of the plurality of light sources are illuminated based on a pose of the body relative to the hand of the user. For example, processor 312 may determine which of LEDs 306 to illuminate based on a pose of hand 310 relative to handheld controller 302. In some aspects, the computing device (or one or more components thereof) may control which light sources of the plurality of light sources are illuminated based on a pose of the body relative to a camera of the object-tracking system. For example, processor 312 may determine which of LEDs 306 to illuminate based on a pose of handheld controller 302 relative to camera 322.

In some aspects, the computing device (or one or more components thereof) may determine a pose of the body relative to a camera of the object-tracking system. In some aspects, the computing device (or one or more components thereof) may receive a signal from the object-tracking system and determine a pose of the body relative to a camera of the object-tracking system based on the signal. In some aspects, the computing device (or one or more components thereof) may determine the pose of the body relative to the camera based on a direction from which the signal is received. For example, processor 312 may determine the relative pose (or a direction) based on the signal (e.g., using a directional antenna). In some aspects, the computing device (or one or more components thereof) may determine the pose of the body relative to the camera based on a message encoded by the signal. For example, processor 312 may determine a pose of handheld controller 302 relative to camera 322 based on a message of the signal (e.g., tracking system 320 may send a message indicating the pose).

In some aspects, the computing device (or one or more components thereof) may control the plurality of light sources based on a signal from the object-tracking system. For example, tracking system 320 may send a message to handheld controller 302 regarding control of LEDs 306. In some aspects, the signal may be indicative of that the object-tracking system is verifying the apparatus. For example, tracking system 320 may inform handheld controller 302 that 320 is verifying handheld controller 302 and processor 312 may control LEDs 306 according to a verification mode. In some aspects, the computing device (or one or more components thereof) may illuminate a first group of the plurality of light sources; and illuminate a second group of the plurality of light sources responsive to the signal from the object-tracking system. For example, handheld controller 302 may illuminate group 602 of LEDs 306, then responsive to a signal from tracking system 320 (e.g., indicative that tracking system 320 is verifying handheld controller 302), handheld controller 302 may illuminate group 612. In some aspects, the signal may be indicative of a frame-capture rate of a camera of the object-tracking system. In some aspects, the computing device (or one or more components thereof) may control a timing of illuminating the plurality of light sources based on the frame-capture rate of the camera. For example, tracking system 320 may inform handheld controller 302 of a frame-capture rate of camera 322 and processor 312 may adjust a timing of LEDs 306 based on the frame-capture rate. In some aspects, the tracking system 320 may transmit a message indicative of a distance between handheld controller 302 and tracking system 320 and processor 312 may control LEDs 306 based on the message. In some aspects, tracking system 320 may transmit a message indicative of a pose of handheld controller 302 (e.g., relative to camera 322 and/or relative to hand 310) and processor 312 may control LEDs 306 based on the message.

In some aspects, the computing device (or one or more components thereof) may measure acceleration and/or rotation of the body and to generate movement information and transmit the movement information to the object-tracking system to enable the object-tracking system to track the body further based on the acceleration and/or rotation of the body. For example, handheld controller 302 may include an IMU 308 and may determine and transmit movement information to tracking system 320.

The components of the computing device can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein.

FIG. 14B is a flow diagram illustrating a process 1400B for improving tracking of a human-machine-interface (HMI) device, in accordance with aspects of the present disclosure. One or more operations of process 1400B may be performed by a computing device (or apparatus) or a component (e.g., a chipset, codec, etc.) of the computing device. The computing device may be a vehicle or component or system of a vehicle, a mobile device (e.g., a mobile phone), a network-connected wearable such as a watch, an extended reality (XR) device such as a virtual reality (VR) device or augmented reality (AR) device, a desktop computing device, a tablet computing device, a server computer, a robotic device,, and/or any other computing device with the resource capabilities to perform the process 1400B. The one or more operations of process 1400B may be implemented as software components that are executed and run on one or more processors.

At block 1402, a computing device (or one or more components thereof) may capture a plurality of images of a tracked object. For example, camera 322 may capture images of handheld controller 302.

At block 1404, the computing device (or one or more components thereof) may communicate with the tracked object. For example, tracking system 320, using communication unit 324, may communicate with handheld controller 302.

In some aspects, the computing device (or one or more components thereof) may detect the tracked object in a first image of the plurality of images; and transmit, to the tracked object a signal indicative that the apparatus is verifying the tracked object. For example, tracking system 320 may detect handheld controller 302, begin a verification process, and send a signal indicative of the verification process to handheld controller 302. In some aspects, the computing device (or one or more components thereof) may detect the tracked object in a second image of the plurality of images. In some aspects, in the first image, a first group of light sources of the tracked object may be illuminated; in the second image a second group of light sources of the tracked object may be illuminated; and the computing device (or one or more components thereof) may verify the tracked object based on the second group of light sources being illuminated in the second image. For example, tracking system 320 may verify handheld controller 302 based on capturing a first image including an illuminated group 602 and a second images including an illuminated group 612.

In some aspects, the computing device (or one or more components thereof) may receive movement information from the tracked object via the communication unit; and determine a pose of the tracked object further based on the movement information. For example, tracking system 320 may receive movement information generated by handheld controller 302 using IMU 308. In some aspects, the movement information may be, or may include, data regarding acceleration and/or rotation of the tracked object.

In some aspects, the computing device (or one or more components thereof) may store a historical pose of the tracked object and wherein the at least one processor is configured to determine a pose of the tracked object based on the historical pose. For example, tracking system 320 may operate as described with regard to historical pose data in FIG. 9.

In some aspects, the computing device (or one or more components thereof) may obtain a hand pose and wherein the at least one processor is configured to determine a pose of the tracked object further based on the hand pose. For example, tracking system 320 may obtain (or determine) a pose of hand 310 and determine a pose of handheld controller 302 based on the pose of hand 310. In some aspects, the computing device (or one or more components thereof) may determine the hand pose based on the plurality of images. In some aspects, the computing device (or one or more components thereof) may store a historical hand pose and wherein, to determine pose of the tracked object, the at least one processor is configured to determine the pose of the tracked object further based on the historical hand pose. For example, tracking system 320 may operate as described with regard to historical hand pose data in FIG. 9.

In some aspects, the computing device (or one or more components thereof) may send a signal indicative of a frame-capture rate of the camera to the tracked object. For example, tracking system 320 may send an indication of a frame-capture rate of camera 322 to handheld controller 302.

In some aspects, the computing device (or one or more components thereof) may transmit a signal indicative of a distance between the apparatus and the camera and the tracked object. For example, tracking system 320 may transmit an indication of the distance between handheld controller 302 and camera 322. In some aspects, the computing device (or one or more components thereof) may transmit a signal indicative of a pose of the tracked object (e.g., relative to a camera of the computing device (or one or more components thereof) or relative to a hand). For example, tracking system 320 may transmit an indication of the pose of handheld controller 302 (e.g., relative to camera 322 and/or relative to hand 310).

At block 1406, the computing device (or one or more components thereof) may track the tracked object based on the plurality of images of the tracked object. In some aspects, the computing device (or one or more components thereof) may determine a pose of the object based on the plurality of images of the tracked object.

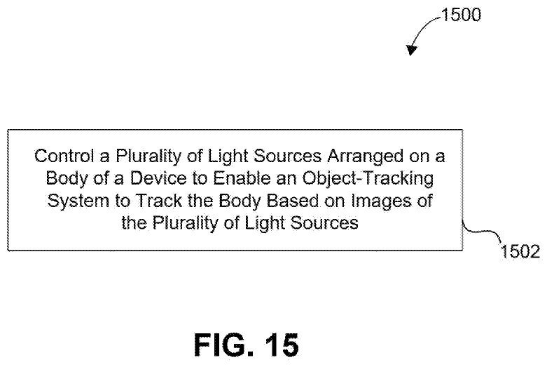

FIG. 15 is a flow diagram illustrating a process 1500 for enabling tracking of an object, in accordance with aspects of the present disclosure. One or more operations of process 1500 may be performed by a computing device (or apparatus) or a component (e.g., a chipset, codec, etc.) of the computing device. The computing device may be a vehicle or component or system of a vehicle, a mobile device (e.g., a mobile phone), a network-connected wearable such as a watch, an extended reality (XR) device such as a virtual reality (VR) device or augmented reality (AR) device, a desktop computing device, a tablet computing device, a server computer, a robotic device, and/or any other computing device with the resource capabilities to perform the process 1500. The one or more operations of process 1500 may be implemented as software components that are executed and run on one or more processors.

At block 1502, a computing device (or one or more components thereof) may control a plurality of light sources arranged on a body of an object to enable an object-tracking system to track the body based on images of the plurality of light sources. For example, processor 326 of FIG. 3B may control LEDs 306 on body 304 of FIG. 3A to enable tracking system 320 to track body 304 based on images of LEDs 306.

In some aspects, the body may be, or may include, a handle.

In some aspects, to control the plurality of light sources, computing device (or one or more components thereof) may independently control each light source of the plurality of light sources. For example, processor 326 may independently control LEDs 306, for example, accordin to design paradigm 412.

In some aspects, to control the plurality of light sources, computing device (or one or more components thereof) may at least one of: control which light sources of the plurality of light sources are illuminated; control a timing of illuminating the plurality of light sources; control an intensity of illuminating the plurality of light sources; or control wavelengths of light emitted by the plurality of light sources. For example, processor 326 may control which of LEDs 306 are illuminated, a timing of illuminating LEDs 306, an intensity of illuminating LEDs 306, a wavelength emitted by LEDs 306.

In some aspects, the computing device (or one or more components thereof) may control which light sources of the plurality of light sources are illuminated based on a distance between the body and a camera of the object-tracking system. For example, processor 326 may control which of LEDs 306 are illuminated based on a distance between body 304 and camera 322.

In some aspects, the computing device (or one or more components thereof) may illuminate a first group of the plurality of light sources responsive to the body being less than a threshold distance from the camera. For example, processor 326 may illuminate group 502 of LEDs 306 based on body 304 being less than a threshold distance from camera 322.

In some aspects, the computing device (or one or more components thereof) may illuminate a second group of the plurality of light sources responsive to the body being greater than a threshold distance from the camera. For example, processor 326 may illuminate group 512 of LEDs 306 based on body 304 being greater than a threshold distance from camera 322.

In some aspects, the computing device (or one or more components thereof) may receive a signal from the object-tracking system, wherein the at least one processor is further configured to determine the distance between the body and the camera based on the signal. For example, processor 326 may receive a signal from tracking system 320 and determine a distance between body 304 and camera 322 based on the signal.

In some aspects, the computing device (or one or more components thereof) may control which light sources of the plurality of light sources are illuminated based on a pose of the body relative to a hand of a user in contact with the handle. For example, processor 326 may control which of LEDs 306 are illuminated based on a pose of handheld controller 302 relative to hand 310.

In some aspects, the computing device (or one or more components thereof) may determine the pose of the body relative to the hand using on the touch sensor. For example, processor 326 may determine a pose of handheld controller 302 relative to hand 310 based on hand sensors 330.

In some aspects, the computing device (or one or more components thereof) may control which light sources of the plurality of light sources are illuminated based on a pose of the body relative to a camera of the object-tracking system. For example, processor 326 may control which of LEDs 306 to illuminate based on a pose of handheld controller 302 relative to camera 322.

In some aspects, the computing device (or one or more components thereof) may receive a signal from the object-tracking system. The computing device (or one or more components thereof) may determine the pose of the body relative to the camera of the object-tracking system based on the signal. For example, processor 326 may receive a signal from tracking system 320 and determine the pose of handheld controller 302 relative to camera 322 based on the signal.

In some aspects, the computing device (or one or more components thereof) may receive signals from the object-tracking system and control the plurality of light sources based on a signal from the object-tracking system. For example, processor 326 may receive a signal from tracking system 320 and control LEDs 306 based on the signal.

In some aspects, the signal may indicate that the object-tracking system is verifying the apparatus. The computing device (or one or more components thereof) may control which light sources of the plurality of light sources that are illuminated based on the signal from the object-tracking system. For example, handheld controller 302 may receive a signal indicating that tracking system 320 is verifying handheld controller 302. Handheld controller 302 may control LEDs 306 according to a validation mode.

In some aspects, the signal may be indicative of a frame-capture rate of a camera of the object-tracking system. The computing device (or one or more components thereof) may control a timing of illuminating the plurality of light sources based on the frame-capture rate of the camera. For example, processor 326 may synchronize illuminating LEDs 306 to a frame-capture rate of camera 322.

In some aspects, the signal may indicate that the object-tracking system is tracking the apparatus. The computing device (or one or more components thereof) may control intensity of illuminating the plurality of light sources based on the signal from the object-tracking system. For example, processor 326 may receive a signal indicating that tracking system 320 is tracking handheld controller 302. Based on the signal, processor 326 may decrease an illumination of LEDs 306.

In some aspects, the computing device (or one or more components thereof) may be included in a controller. For example, the computing device (or one or more components thereof) may be processor 326 of handheld controller 302.

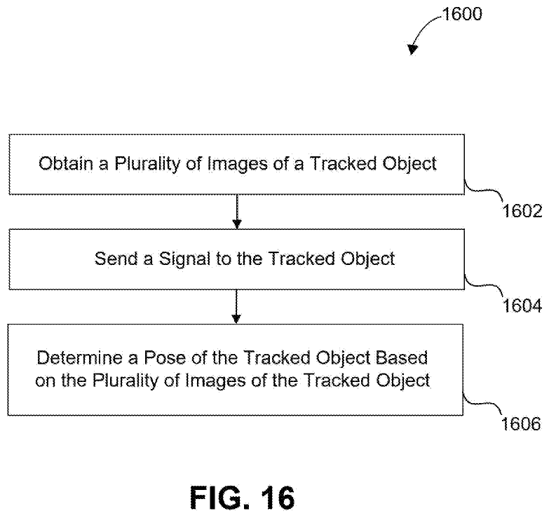

FIG. 16 is a flow diagram illustrating a process 1600 for tracking an object, in accordance with aspects of the present disclosure. One or more operations of process 1600 may be performed by a computing device (or apparatus) or a component (e.g., a chipset, codec, etc.) of the computing device. The computing device may be a vehicle or component or system of a vehicle, a mobile device (e.g., a mobile phone), a network-connected wearable such as a watch, an extended reality (XR) device such as a virtual reality (VR) device or augmented reality (AR) device, a desktop computing device, a tablet computing device, a server computer, a robotic device, and/or any other computing device with the resource capabilities to perform the process 1600. The one or more operations of process 1600 may be implemented as software components that are executed and run on one or more processors.

At block 1602, a computing device (or one or more components thereof) may obtain a plurality of images of a tracked object. For example, camera 322 of FIG. 3A may capture images of handheld controller 302.

At block 1604, the computing device (or one or more components thereof) may send a signal to the tracked object. For example, tracking system 320 of FIG. 3A may send a signal to handheld controller 302.

In some aspects, the computing device (or one or more components thereof) may transmit, to the tracked object, a signal indicative of a distance between the camera and the tracked object. For example, tracking system 320 may transmit to handheld controller 302 a signal indicative of a distance between camera 322 and handheld controller 302.

In some aspects, the computing device (or one or more components thereof) may determine a pose of the tracked object relative to the camera; and transmit, to the tracked object, a signal indicative of the pose of the tracked object relative to the camera, for example, tracking system 320 may determine a pose of handheld controller 302 relative to camera 322 and transmit an indication of the pose to handheld controller 302.

In some aspects, the computing device (or one or more components thereof) may determine a pose of the tracked object relative to a hand holding the tracked object; and transmit, to the tracked object a signal indicative of the pose of the tracked object relative to the hand. For example, tracking system 320 may determine a pose of handheld controller 302 relative to hand 310 and transmit a signal to handheld controller 302 indicative of the pose.

In some aspects, the computing device (or one or more components thereof) may transmit a signal indicating that the apparatus is tracking the tracked object. For example, tracking system 320 may track handheld controller 302 and send a signal indicating that tracking system 320 is tracking handheld controller 302.

In some aspects, the computing device (or one or more components thereof) may send a signal indicative of a frame-capture rate of the camera to the tracked object. For example, tracking system 320 may transmit a signal indicative of a frame-capture rate of camera 322 to handheld controller 302.

In some aspects, the computing device (or one or more components thereof) may detect the tracked object in a first image of the plurality of images; and transmit, to the tracked object, via the communication unit, a signal indicating that the apparatus is verifying the tracked object. For example, tracking system 320 may detect handheld controller 302 in a first image and begin verifying handheld controller 302. Further, tracking system 320 may send a signal to handheld controller 302 indicating that tracking system 320 is verifying handheld controller 302.

In some aspects, the computing device (or one or more components thereof) may detect the tracked object in a second image of the plurality of images; and verify the tracked object based on a group of light sources illuminated in the second image. For example, tracking system 320 may detect handheld controller 302 in a second image and verify handheld controller 302 based on the group of LEDs 306 that are illuminated.

At block 1606, the computing device (or one or more components thereof) may determine a pose of the tracked object based on the plurality of images of the tracked object. For example, tracking system 320 may determine a pose of handheld controller 302 based on images of handheld controller 302.

In some aspects, the computing device (or one or more components thereof) may detect the tracked object based on a group of light sources illuminated in an image of the plurality of images. For example, tracking system 320 may detect handheld controller 302 based on a group of LEDs 306 illuminated by handheld controller 302.

In some aspects, the computing device (or one or more components thereof) may obtain a hand pose of a hand holding the tracked object; and determine a pose of the tracked object further based on the hand pose. For example, tracking system 320 may determine a pose of handheld controller 302 based, at least in part, on a pose of hand 310.

In some aspects, the computing device (or one or more components thereof) may determine the hand pose based on the plurality of images. For example, tracking system 320 may determine the pose of hand 310 based on the images obtained at block 1602.

In some aspects, the computing device (or one or more components thereof) may determine a plurality of image features based on the plurality of images; and determine the pose of the tracked object further based on the plurality of image features. For example, tracking system 320 may determine a plurality of image features based on the images obtained at block 1602 and determine the pose of handheld controller 302 based, at least in part, on the image features.

In some aspects, the plurality of image features may be based on at least one of representations of the tracked object in the plurality of images or representations of a hand holding the tracked object in the plurality of images. For example, the image features may be based on handheld controller 302 and/or hand 310.

In some aspects, the computing device (or one or more components thereof) may be included in a head-mounted device. For example, tracking system 320 may be included in a XR HMD.

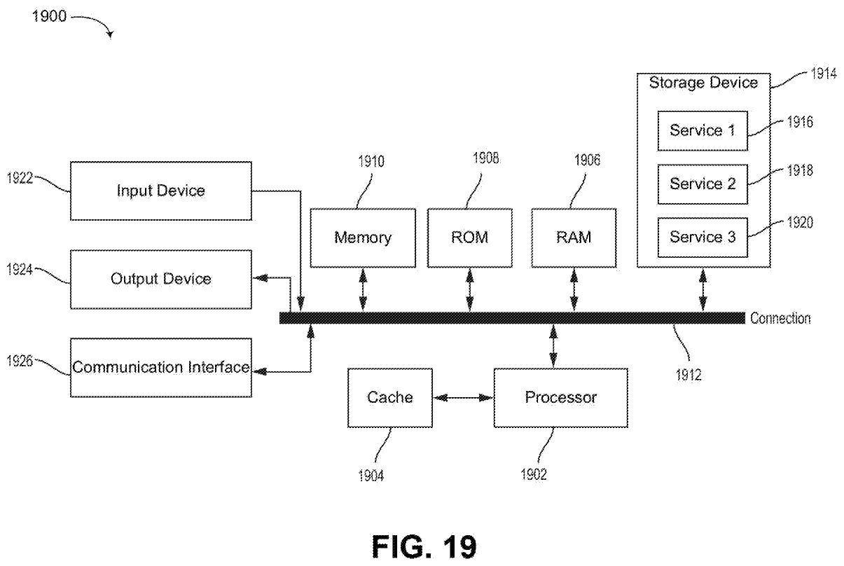

In some examples, as noted previously, the methods described herein (e.g., process 1400A of FIG. 14A, 1400B of FIG. 14B, process 1500 of FIG. 15, process 1600 of FIG. 16 and/or other methods described herein) can be performed, in whole or in part, by a computing device or apparatus. In one example, one or more of the methods can be performed by handheld controller 200 of FIG. 2, system 300 of FIG. 3, handheld controller 302 of FIG. 3A, FIG. 3B, FIG. 8, FIG. 9, and FIG. 10 tracking system 320 of FIG. 3A, FIG. 3B, FIG. 8, FIG. 9, and FIG. 10 or by another system or device. In another example, one or more of the methods (e.g., process 1400A, process 1400B, process 1500, process 1600, and/or other methods described herein) can be performed, in whole or in part, by the computing-device architecture 1900 shown in FIG. 19. For instance, a computing device with the computing-device architecture 1900 shown in FIG. 19 can include, or be included in, the components of the handheld controller 200, system 300, handheld controller 302, and/or tracking system 320 and can implement the operations of process 1400A, process 1400B, process 1500, and/or process 1600, and/or other process described herein. In some cases, the computing device or apparatus can include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device can include a display, a network interface configured to communicate and/or receive the data, any combination thereof, and/or other component(s). The network interface can be configured to communicate and/or receive Internet Protocol (IP) based data or other type of data.

The components of the computing device can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein.

Process 1400A, process 1400B, process 1500, process 1600, and/or other process described herein are illustrated as logical flow diagrams, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, process 1400A, process 1400B, process 1500, process 1600, and/or other process described herein can be performed under the control of one or more computer systems configured with executable instructions and can be implemented as code (e.g., executable instructions, one or more computer programs, or one or more applications) executing collectively on one or more processors, by hardware, or combinations thereof. As noted above, the code can be stored on a computer-readable or machine-readable storage medium, for example, in the form of a computer program comprising a plurality of instructions executable by one or more processors. The computer-readable or machine-readable storage medium can be non-transitory.

As noted above, various aspects of the present disclosure can use machine-learning models or systems.

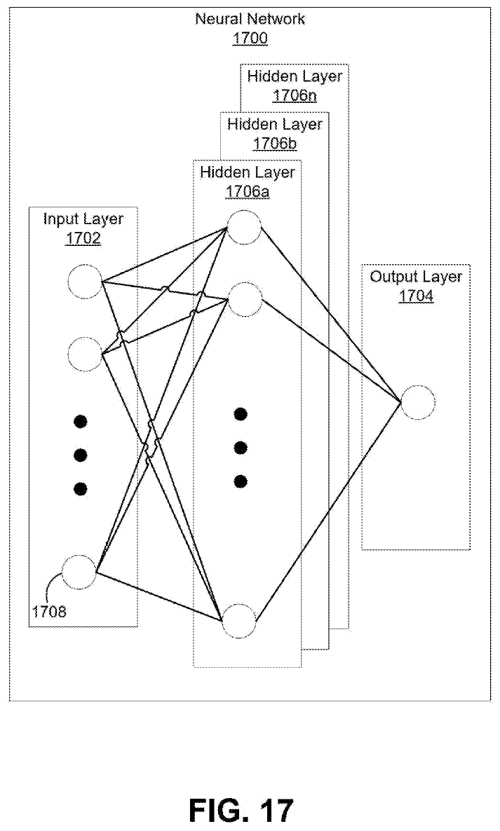

FIG. 17 is a diagram illustrating an example of a neural network 1700 (e.g., a deep-learning neural network) that can be used to implement the machine-learning based feature extraction, object detection, object tracking, vehicle tracking, vehicle detection, lane detection, lane tracking, feature segmentation, implicit-neural-representation generation, rendering, and/or classification described above.

An input layer 1702 includes input data. In one illustrative example, input layer 1702 can include data representing images captured by camera 322. Neural network 1700 includes multiple hidden layers hidden layers 1706a, 1706b, through 1706n. The hidden layers 1706a, 1706b, through hidden layer 1706n include “n” number of hidden layers, where “n” is an integer greater than or equal to one. The number of hidden layers can be made to include as many layers as needed for the given application. Neural network 1700 further includes an output layer 1704 that provides an output resulting from the processing performed by the hidden layers 1706a, 1706b, through 1706n. In one illustrative example, output layer 1704 can provide image features.

Neural network 1700 can be, or can include, a multi-layer neural network of interconnected nodes. Each node can represent a piece of information. Information associated with the nodes is shared among the different layers and each layer retains information as information is processed. In some cases, neural network 1700 can include a feed-forward network, in which case there are no feedback connections where outputs of the network are fed back into itself. In some cases, neural network 1700 can include a recurrent neural network, which can have loops that allow information to be carried across nodes while reading in input.

Information can be exchanged between nodes through node-to-node interconnections between the various layers. Nodes of input layer 1702 can activate a set of nodes in the first hidden layer 1706a. For example, as shown, each of the input nodes of input layer 1702 is connected to each of the nodes of the first hidden layer 1706a. The nodes of first hidden layer 1706a can transform the information of each input node by applying activation functions to the input node information. The information derived from the transformation can then be passed to and can activate the nodes of the next hidden layer 1706b, which can perform their own designated functions. Example functions include convolutional, up-sampling, data transformation, and/or any other suitable functions. The output of the hidden layer 1706b can then activate nodes of the next hidden layer, and so on. The output of the last hidden layer 1706n can activate one or more nodes of the output layer 1704, at which an output is provided. In some cases, while nodes (e.g., node 1708) in neural network 1700 are shown as having multiple output lines, a node has a single output and all lines shown as being output from a node represent the same output value.

In some cases, each node or interconnection between nodes can have a weight that is a set of parameters derived from the training of neural network 1700. Once neural network 1700 is trained, it can be referred to as a trained neural network, which can be used to perform one or more operations. For example, an interconnection between nodes can represent a piece of information learned about the interconnected nodes. The interconnection can have a tunable numeric weight that can be tuned (e.g., based on a training dataset), allowing neural network 1700 to be adaptive to inputs and able to learn as more and more data is processed.

Neural network 1700 may be pre-trained to process the features from the data in the input layer 1702 using the different hidden layers 1706a, 1706b, through 1706n in order to provide the output through the output layer 1704. In an example in which neural network 1700 is used to identify features in images, neural network 1700 can be trained using training data that includes both images and labels, as described above. For instance, training images can be input into the network, with each training image having a label indicating the features in the images (for the feature-segmentation machine-learning system) or a label indicating classes of an activity in each image. In one example using object classification for illustrative purposes, a training image can include an image of a number 2, in which case the label for the image can be [001000000 0].

In some cases, neural network 1700 can adjust the weights of the nodes using a training process called backpropagation. As noted above, a backpropagation process can include a forward pass, a loss function, a backward pass, and a weight update. The forward pass, loss function, backward pass, and parameter update is performed for one training iteration. The process can be repeated for a certain number of iterations for each set of training images until neural network 1700 is trained well enough so that the weights of the layers are accurately tuned.

For the example of identifying objects in images, the forward pass can include passing a training image through neural network 1700. The weights are initially randomized before neural network 1700 is trained. As an illustrative example, an image can include an array of numbers representing the pixels of the image. Each number in the array can include a value from 0 to 255 describing the pixel intensity at that position in the array. In one example, the array can include a 28×28×3 array of numbers with 28 rows and 28 columns of pixels and 3 color components (such as red, green, and blue, or luma and two chroma components, or the like).

As noted above, for a first training iteration for neural network 1700, the output will likely include values that do not give preference to any particular class due to the weights being randomly selected at initialization. For example, if the output is a vector with probabilities that the object includes different classes, the probability value for each of the different classes can be equal or at least very similar (e.g., for ten possible classes, each class can have a probability value of 0.1). With the initial weights, neural network 1700 is unable to determine low-level features and thus cannot make an accurate determination of what the classification of the object might be. A loss function can be used to analyze error in the output. Any suitable loss function definition can be used, such as a cross-entropy loss. Another example of a loss function includes the mean squared error (MSE), defined as

$${E}_{total} = \sum \frac{1}{2} {( target - ouput )}^{2} .$$

The loss can be set to be equal to the value of Eₜₒₜₐₗ.

The loss (or error) will be high for the first training images since the actual values will be much different than the predicted output. The goal of training is to minimize the amount of loss so that the predicted output is the same as the training label. Neural network 1700 can perform a backward pass by determining which inputs (weights) most contributed to the loss of the network and can adjust the weights so that the loss decreases and is eventually minimized. A derivative of the loss with respect to the weights (denoted as dL/dW, where W are the weights at a particular layer) can be computed to determine the weights that contributed most to the loss of the network. After the derivative is computed, a weight update can be performed by updating all the weights of the filters. For example, the weights can be updated so that they change in the opposite direction of the gradient. The weight update can be denoted as

$$w = {w}_{i} - η \frac{d L}{d W} ,$$

where w denotes a weight, wᵢ denotes the initial weight, and n denotes a learning rate. The learning rate can be set to any suitable value, with a high learning rate including larger weight updates and a lower value indicating smaller weight updates.

Neural network 1700 can include any suitable deep network. One example includes a convolutional neural network (CNN), which includes an input layer and an output layer, with multiple hidden layers between the input and out layers. The hidden layers of a CNN include a series of convolutional, nonlinear, pooling (for downsampling), and fully connected layers. Neural network 1700 can include any other deep network other than a CNN, such as an autoencoder, a deep belief nets (DBNs), a Recurrent Neural Networks (RNNs), among others.

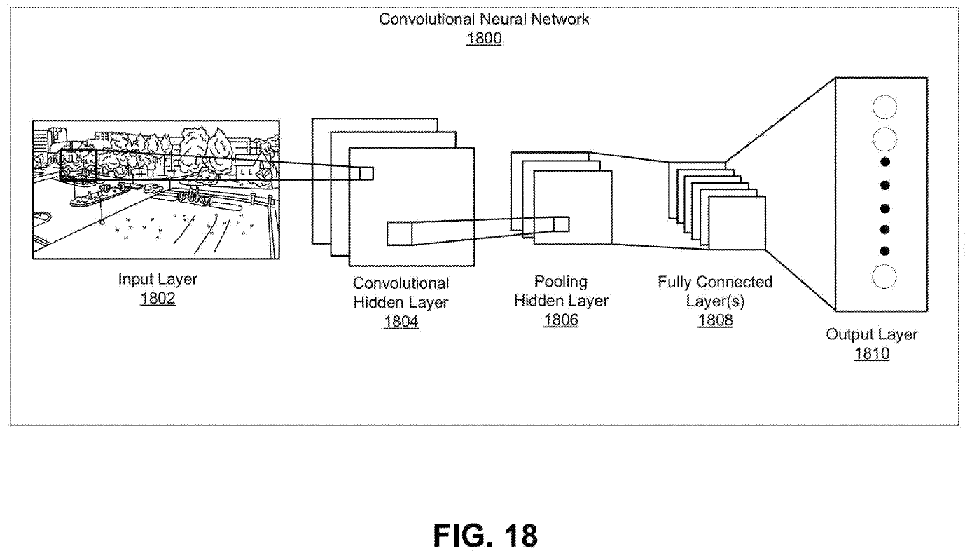

FIG. 18 is a diagram illustrating an example of a convolutional neural network (CNN) 1800. The input layer 1802 of the CNN 1800 includes data representing an image or frame. For example, the data can include an array of numbers representing the pixels of the image, with each number in the array including a value from 0 to 255 describing the pixel intensity at that position in the array. Using the previous example from above, the array can include a 28×28×3 array of numbers with 28 rows and 28 columns of pixels and 3 color components (e.g., red, green, and blue, or luma and two chroma components, or the like). The image can be passed through a convolutional hidden layer 1804, an optional non-linear activation layer, a pooling hidden layer 1806, and fully connected layer 1808 (which fully connected layer 1808 can be hidden) to get an output at the output layer 1810. While only one of each hidden layer is shown in FIG. 18, one of ordinary skill will appreciate that multiple convolutional hidden layers, non-linear layers, pooling hidden layers, and/or fully connected layers can be included in the CNN 1800. As previously described, the output can indicate a single class of an object or can include a probability of classes that best describe the object in the image.

The first layer of the CNN 1800 can be the convolutional hidden layer 1804. The convolutional hidden layer 1804 can analyze image data of the input layer 1802. Each node of the convolutional hidden layer 1804 is connected to a region of nodes (pixels) of the input image called a receptive field. The convolutional hidden layer 1804 can be considered as one or more filters (each filter corresponding to a different activation or feature map), with each convolutional iteration of a filter being a node or neuron of the convolutional hidden layer 1804. For example, the region of the input image that a filter covers at each convolutional iteration would be the receptive field for the filter. In one illustrative example, if the input image includes a 28×28 array, and each filter (and corresponding receptive field) is a 5×5 array, then there will be 24×24 nodes in the convolutional hidden layer 1804. Each connection between a node and a receptive field for that node learns a weight and, in some cases, an overall bias such that each node learns to analyze its particular local receptive field in the input image. Each node of the convolutional hidden layer 1804 will have the same weights and bias (called a shared weight and a shared bias). For example, the filter has an array of weights (numbers) and the same depth as the input. A filter will have a depth of 3 for an image frame example (according to three color components of the input image). An illustrative example size of the filter array is 5×5 x 3, corresponding to a size of the receptive field of a node.

The convolutional nature of the convolutional hidden layer 1804 is due to each node of the convolutional layer being applied to its corresponding receptive field. For example, a filter of the convolutional hidden layer 1804 can begin in the top-left corner of the input image array and can convolve around the input image. As noted above, each convolutional iteration of the filter can be considered a node or neuron of the convolutional hidden layer 1804. At each convolutional iteration, the values of the filter are multiplied with a corresponding number of the original pixel values of the image (e.g., the 5×5 filter array is multiplied by a 5×5 array of input pixel values at the top-left corner of the input image array). The multiplications from each convolutional iteration can be summed together to obtain a total sum for that iteration or node. The process is next continued at a next location in the input image according to the receptive field of a next node in the convolutional hidden layer 1804. For example, a filter can be moved by a step amount (referred to as a stride) to the next receptive field. The stride can be set to 1 or any other suitable amount. For example, if the stride is set to 1, the filter will be moved to the right by 1 pixel at each convolutional iteration. Processing the filter at each unique location of the input volume produces a number representing the filter results for that location, resulting in a total sum value being determined for each node of the convolutional hidden layer 1804.

The mapping from the input layer to the convolutional hidden layer 1804 is referred to as an activation map (or feature map). The activation map includes a value for each node representing the filter results at each location of the input volume. The activation map can include an array that includes the various total sum values resulting from each iteration of the filter on the input volume. For example, the activation map will include a 24×24 array if a 5×5 filter is applied to each pixel (a stride of 1) of a 28×28 input image. The convolutional hidden layer 1804 can include several activation maps in order to identify multiple features in an image. The example shown in FIG. 18 includes three activation maps. Using three activation maps, the convolutional hidden layer 1804 can detect three different kinds of features, with each feature being detectable across the entire image.

In some examples, a non-linear hidden layer can be applied after the convolutional hidden layer 1804. The non-linear layer can be used to introduce non-linearity to a system that has been computing linear operations. One illustrative example of a non-linear layer is a rectified linear unit (ReLU) layer. A ReLU layer can apply the function f(x)=max (0, x) to all of the values in the input volume, which changes all the negative activations to 0. The ReLU can thus increase the non-linear properties of the CNN 1800 without affecting the receptive fields of the convolutional hidden layer 1804.

The pooling hidden layer 1806 can be applied after the convolutional hidden layer 1804 (and after the non-linear hidden layer when used). The pooling hidden layer 1806 is used to simplify the information in the output from the convolutional hidden layer 1804. For example, the pooling hidden layer 1806 can take each activation map output from the convolutional hidden layer 1804 and generates a condensed activation map (or feature map) using a pooling function. Max-pooling is one example of a function performed by a pooling hidden layer. Other forms of pooling functions be used by the pooling hidden layer 1806, such as average pooling, L2-norm pooling, or other suitable pooling functions. A pooling function (e.g., a max-pooling filter, an L2-norm filter, or other suitable pooling filter) is applied to each activation map included in the convolutional hidden layer 1804. In the example shown in FIG. 18, three pooling filters are used for the three activation maps in the convolutional hidden layer 1804.

In some examples, max-pooling can be used by applying a max-pooling filter (e.g., having a size of 2×2) with a stride (e.g., equal to a dimension of the filter, such as a stride of 2) to an activation map output from the convolutional hidden layer 1804. The output from a max-pooling filter includes the maximum number in every sub-region that the filter convolves around. Using a 2×2 filter as an example, each unit in the pooling layer can summarize a region of 2×2 nodes in the previous layer (with each node being a value in the activation map). For example, four values (nodes) in an activation map will be analyzed by a 2×2 max-pooling filter at each iteration of the filter, with the maximum value from the four values being output as the “max” value. If such a max-pooling filter is applied to an activation filter from the convolutional hidden layer 1804 having a dimension of 24×24 nodes, the output from the pooling hidden layer 1806 will be an array of 12×12 nodes.

In some examples, an L2-norm pooling filter could also be used. The L2-norm pooling filter includes computing the square root of the sum of the squares of the values in the 2×2 region (or other suitable region) of an activation map (instead of computing the maximum values as is done in max-pooling) and using the computed values as an output.

The pooling function (e.g., max-pooling, L2-norm pooling, or other pooling function) determines whether a given feature is found anywhere in a region of the image and discards the exact positional information. This can be done without affecting results of the feature detection because, once a feature has been found, the exact location of the feature is not as important as its approximate location relative to other features. Max-pooling (as well as other pooling methods) offer the benefit that there are many fewer pooled features, thus reducing the number of parameters needed in later layers of the CNN 1800.

The final layer of connections in the network is a fully-connected layer that connects every node from the pooling hidden layer 1806 to every one of the output nodes in the output layer 1810. Using the example above, the input layer includes 28×28 nodes encoding the pixel intensities of the input image, the convolutional hidden layer 1804 includes 3×24×24 hidden feature nodes based on application of a 5×5 local receptive field (for the filters) to three activation maps, and the pooling hidden layer 1806 includes a layer of 3×12×12 hidden feature nodes based on application of max-pooling filter to 2×2 regions across each of the three feature maps. Extending this example, the output layer 1810 can include ten output nodes. In such an example, every node of the 3×12×12 pooling hidden layer 1806 is connected to every node of the output layer 1810.

The fully connected layer 1808 can obtain the output of the previous pooling hidden layer 1806 (which should represent the activation maps of high-level features) and determines the features that most correlate to a particular class. For example, the fully connected layer 1808 can determine the high-level features that most strongly correlate to a particular class and can include weights (nodes) for the high-level features. A product can be computed between the weights of the fully connected layer 1808 and the pooling hidden layer 1806 to obtain probabilities for the different classes. For example, if the CNN 1800 is being used to predict that an object in an image is a person, high values will be present in the activation maps that represent high-level features of people (e.g., two legs are present, a face is present at the top of the object, two eyes are present at the top left and top right of the face, a nose is present in the middle of the face, a mouth is present at the bottom of the face, and/or other features common for a person).

In some examples, the output from the output layer 1810 can include an M-dimensional vector (in the prior example, M=10). M indicates the number of classes that the CNN 1800 has to choose from when classifying the object in the image. Other example outputs can also be provided. Each number in the M-dimensional vector can represent the probability the object is of a certain class. In one illustrative example, if a 10-dimensional output vector represents ten different classes of objects is [0 0 0.05 0.8 0 0.15 0 0 0 0], the vector indicates that there is a 5% probability that the image is the third class of object (e.g., a dog), an 80% probability that the image is the fourth class of object (e.g., a human), and a 15% probability that the image is the sixth class of object (e.g., a kangaroo). The probability for a class can be considered a confidence level that the object is part of that class.

FIG. 19 is a diagram illustrating an example computing-device architecture 1900 of an example computing device which can implement the various techniques described herein. In some examples, the computing device can include a mobile device, a wearable device, an extended reality device (e.g., a virtual reality (VR) device, an augmented reality (AR) device, or a mixed reality (MR) device), a personal computer, a laptop computer, a video server, a vehicle (or computing device of a vehicle), or other device. For example, the computing-device architecture 1900 may include, implement, or be included in any or all of system 300 of FIG. 3, system 600 of FIG. 6, the handheld controller and/or the tracking system configured to perform the process illustrated by the flow diagram 700 of FIG. 7, system 800 of FIG. 8, the tracking system configured to perform the process illustrated by the flow diagram 900 of FIG. 9, the system 1000 of FIG. 10, the system 1200 of FIG. 12, and/or other devices, components or modules, or systems described herein.

The components of computing-device architecture 1900 are shown in electrical communication with each other using connection 1912, such as a bus. The example computing-device architecture 1900 includes a processing unit (CPU or processor) 1902 and computing device connection 1912 that couples various computing device components including computing device memory 1910, such as read only memory (ROM) 1908 and random-access memory (RAM) 1906, to processor 1902.

Computing-device architecture 1900 can include a cache of high-speed memory connected directly with, in close proximity to, or integrated as part of processor 1902. Computing-device architecture 1900 can copy data from memory 1910 and/or the storage device 1914 to cache 1904 for quick access by processor 1902. In this way, the cache can provide a performance boost that avoids processor 1902 delays while waiting for data. These and other modules can control or be configured to control processor 1902 to perform various actions. Other computing device memory 1910 may be available for use as well. Memory 1910 can include multiple different types of memory with different performance characteristics. Processor 1902 can include any general-purpose processor and a hardware or software service, such as service 1 1916, service 2 1918, and service 3 1920 stored in storage device 1914, configured to control processor 1902 as well as a special-purpose processor where software instructions are incorporated into the processor design. Processor 1902 may be a self-contained system, containing multiple cores or processors, a bus, memory controller, cache, etc. A multi-core processor may be symmetric or asymmetric.

To enable user interaction with the computing-device architecture 1900, input device 1922 can represent any number of input mechanisms, such as a microphone for speech, a touch-sensitive screen for gesture or graphical input, keyboard, mouse, motion input, speech and so forth. Output device 1924 can also be one or more of a number of output mechanisms known to those of skill in the art, such as a display, projector, television, speaker device, etc. In some instances, multimodal computing devices can enable a user to provide multiple types of input to communicate with computing-device architecture 1900. Communication interface 1926 can generally govern and manage the user input and computing device output. There is no restriction on operating on any particular hardware arrangement and therefore the basic features here may easily be substituted for improved hardware or firmware arrangements as they are developed.

Storage device 1914 is a non-volatile memory and can be a hard disk or other types of computer readable media which can store data that are accessible by a computer, such as magnetic cassettes, flash memory cards, solid state memory devices, digital versatile disks, cartridges, random-access memories (RAMs) 1906, read only memory (ROM) 1908, and hybrids thereof. Storage device 1914 can include services 1916, 1918, and 1920 for controlling processor 1902. Other hardware or software modules are contemplated. Storage device 1914 can be connected to the computing device connection 1912. In one aspect, a hardware module that performs a particular function can include the software component stored in a computer-readable medium in connection with the necessary hardware components, such as processor 1902, connection 1912, output device 1924, and so forth, to carry out the function.

The term “substantially,” in reference to a given parameter, property, or condition, may refer to a degree that one of ordinary skill in the art would understand that the given parameter, property, or condition is met with a small degree of variance, such as, for example, within acceptable manufacturing tolerances. By way of example, depending on the particular parameter, property, or condition that is substantially met, the parameter, property, or condition may be at least 90% met, at least 95% met, or even at least 99% met.

Aspects of the present disclosure are applicable to any suitable electronic device (such as security systems, smartphones, tablets, laptop computers, vehicles, drones, or other devices) including or coupled to one or more active depth sensing systems. While described below with respect to a device having or coupled to one light projector, aspects of the present disclosure are applicable to devices having any number of light projectors and are therefore not limited to specific devices.

The term “device” is not limited to one or a specific number of physical objects (such as one smartphone, one controller, one processing system and so on). As used herein, a device may be any electronic device with one or more parts that may implement at least some portions of this disclosure. While the below description and examples use the term “device” to describe various aspects of this disclosure, the term “device” is not limited to a specific configuration, type, or number of objects. Additionally, the term “system” is not limited to multiple components or specific aspects. For example, a system may be implemented on one or more printed circuit boards or other substrates and may have movable or static components. While the below description and examples use the term “system” to describe various aspects of this disclosure, the term “system” is not limited to a specific configuration, type, or number of objects.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks including functional blocks including devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, magnetic or optical disks, USB devices provided with non-volatile memory, networked storage devices, any suitable combination thereof, among others. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some aspects the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

The various illustrative logical blocks, modules, circuits, and algorithm steps described in connection with the aspects disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general-purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium including program code including instructions that, when executed, performs one or more of the methods described above. The computer-readable data storage medium may form part of a computer program product, which may include packaging materials. The computer-readable medium may include memory or data storage media, such as random-access memory (RAM) such as synchronous dynamic random-access memory (SDRAM), read-only memory (ROM), non-volatile random-access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general-purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration). Accordingly, the term “processor,” as used herein may refer to any of the foregoing structure, any combination of the foregoing structure, or any other structure or apparatus suitable for implementation of the techniques described herein.

Claim language or other language reciting “at least one processor configured to,” “at least one processor being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Illustrative aspects of the disclosure include:

Aspect 1. An apparatus enabling tracking of an object, the apparatus comprising: a body comprising a handle to be held in a hand of a user; a plurality of light sources arranged on the body; and at least one processor configured to adaptively adjust a pattern of the plurality of light sources to enable an object-tracking system to track the body based on images of the plurality of light sources.

Aspect 2. An apparatus enabling tracking of an object, the apparatus comprising: a body comprising a handle to be held in a hand of a user; a plurality of light sources arranged on the body; and at least one processor configured to control the plurality of light sources to enable an object-tracking system to track the body based on images of the plurality of light sources.

Aspect 3. The apparatus of aspect 2, wherein, to control the plurality of light sources, the at least one processor is configured to independently control each light source of the plurality of light sources.

Aspect 4. The apparatus of any one of aspect 2 or 3, wherein, to control the plurality of light sources, the at least one processor is configured to control at least one of: light sources of the plurality of light sources that are illuminated; a timing of illuminating the plurality of light sources; an intensity of illuminating the plurality of light sources; or wavelengths of light produced by the plurality of light sources.

Aspect 5. The apparatus of any one of aspect 2 to 4, wherein each light source of the plurality of light sources comprises one or more respective light-emitting diodes (LEDs).

Aspect 6. The apparatus of any one of aspect 2 to 5, wherein each light source of the plurality of light sources is configured to emit at least one of visible light, near infrared light, or infrared light.

Aspect 7. The apparatus of any one of aspect 2 to 6, wherein the at least one processor is further configured to control the plurality of light sources based on a distance between the body and a camera of the object-tracking system.

Aspect 8. The apparatus of aspect 7, wherein the at least one processor is further configured to control which light sources of the plurality of light sources are illuminated based on the distance between the body and the camera.

Aspect 9. The apparatus of any one of aspect 7 or 8, wherein the at least one processor is further configured to: determine whether the body is greater than a threshold distance from the camera of the object-tracking system; and control the plurality of light sources based on whether the body is greater than the threshold distance from the camera.

Aspect 10. The apparatus of aspect 9, wherein the at least one processor is further configured to: illuminate a first group of the plurality of light sources responsive to the body being less than the threshold distance from the camera; and illuminate a second group of the plurality of light sources responsive to the body being greater than the threshold distance from the camera.

Aspect 11. The apparatus of aspect 10, wherein the second group comprises fewer light sources than the first group.

Aspect 12. The apparatus of any one of aspect 7 to 11, further comprising a communication unit configured to receive a signal from the object-tracking system, wherein the at least one processor is further configured to determine the distance between the body and the camera based on the signal.

Aspect 13. The apparatus of aspect 12, wherein the at least one processor is further configured to determine the distance between the body and the camera based on a strength of the signal.

Aspect 14. The apparatus of any one of aspect 12 or 13, wherein the at least one processor is further configured to determine the distance between the body and the camera based on a message encoded by the signal.

Aspect 15. The apparatus of any one of aspect 7 to 14, wherein, to control the plurality of light sources based on the distance between the body and a camera of the object-tracking system, the at least one processor is configured to control at least one of: which light sources of the plurality of light sources are illuminated; a timing of illuminating the plurality of light sources; an intensity of illuminating the plurality of light sources; or wavelengths of light produced by the plurality of light sources.

Aspect 16. The apparatus of any one of aspect 2 to 15, wherein the at least one processor is further configured to control the plurality of light sources based on a pose of the body.

Aspect 17. The apparatus of aspect 16, wherein the at least one processor is further configured to control which light sources of the plurality of light sources are illuminated based on a pose of the body relative to the hand of the user.

Aspect 18. The apparatus of any one of aspect 16 or 17, wherein the at least one processor is further configured to control which light sources of the plurality of light sources are illuminated based on a pose of the body relative to a camera of the object-tracking system.

Aspect 19. The apparatus of any one of aspect 16 to 18, further comprising a communication unit configured to receive a signal from the object-tracking system, wherein the at least one processor is further configured to determine a pose of the body relative to a camera of the object-tracking system based on the signal.

Aspect 20. The apparatus of aspect 19, wherein the at least one processor is further configured to determine the pose of the body relative to the camera based on a direction from which the signal is received.

Aspect 21. The apparatus of any one of aspect 19 or 20, wherein the at least one processor is further configured to determine the pose of the body relative to the camera based on a message encoded by the signal.

Aspect 22. The apparatus of any one of aspect 2 to 21, wherein the at least one processor is further configured to control the plurality of light sources based on a signal from the object-tracking system.

Aspect 23. The apparatus of aspect 22, wherein the signal is indicative of that the object-tracking system is verifying the apparatus.

Aspect 24. The apparatus of any one of aspect 22 or 23, wherein the at least one processor is further configured to: illuminate a first group of the plurality of light sources; and illuminate a second group of the plurality of light sources responsive to the signal from the object-tracking system.

Aspect 25. The apparatus of any one of aspect 22 to 24, wherein, to control the plurality of light sources based on a signal from the object-tracking system, the at least one processor is configured to control at least one of: which light sources of the plurality of light sources are illuminated; a timing of illuminating the plurality of light sources; an intensity of illuminating the plurality of light sources; or wavelengths of light produced by the plurality of light sources.

Aspect 26. The apparatus of any one of aspect 22 to 25, wherein the signal is indicative of a frame-capture rate of a camera of the object-tracking system.

Aspect 27. The apparatus of aspect 26, wherein the at least one processor is further configured to control a timing of illuminating the plurality of light sources based on the frame-capture rate of the camera.

Aspect 28. The apparatus of any one of aspect 2 to 27, further comprising: an inertial measurement unit (IMU) configured to measure acceleration and/or rotation of the body and to generate movement information; and a communication unit configured to transmit the movement information to the object-tracking system to enable the object-tracking system to track the body further based on the acceleration and/or rotation of the body.

Aspect 29. An apparatus for tracking an object, the apparatus comprising: a camera configured to capture a plurality of images of a tracked object; a communication unit configured to communicate with the tracked object; and at least one processor configured to track the tracked object based on the plurality of images of the tracked object.

Aspect 30. The apparatus of aspect 29, wherein the at least one processor is configured to: detect the tracked object in a first image of the plurality of images; and transmit, to the tracked object, via the communication unit, a signal indicative that the apparatus is verifying the tracked object.

Aspect 31. The apparatus of aspect 30, wherein the at least one processor is configured to detect the tracked object in a second image of the plurality of images.

Aspect 32. The apparatus of aspect 31, wherein: in the first image, a first group of light sources of the tracked object is illuminated; in the second image a second group of light sources of the tracked object is illuminated; and the at least one processor is further configured to verify the tracked object based on the second group of light sources being illuminated in the second image.

Aspect 33. The apparatus of any one of aspect 29 to 32, wherein the at least one processor is further configured to: receive movement information from the tracked object via the communication unit; and determine a pose of the tracked object further based on the movement information.

Aspect 34. The apparatus of aspect 33, wherein the movement information comprises data regarding acceleration and/or rotation of the tracked object.

Aspect 35. The apparatus of any one of aspect 29 to 34, wherein the at least one processor is configured to store a historical pose of the tracked object and wherein the at least one processor is configured to determine a pose of the tracked object based on the historical pose.

Aspect 36. The apparatus of any one of aspect 29 to 35, wherein the at least one processor is further configured to obtain a hand pose and wherein the at least one processor is configured to determine a pose of the tracked object further based on the hand pose.

Aspect 37. The apparatus of aspect 36, wherein the at least one processor is further configured to determine the hand pose based on the plurality of images.

Aspect 38. The apparatus of any one of aspect 35 to 37, wherein the at least one processor is configured to store a historical hand pose and wherein, to determine pose of the tracked object, the at least one processor is configured to determine the pose of the tracked object further based on the historical hand pose.

Aspect 39. The apparatus of any one of aspect 29 to 38, wherein the communication unit is configured send a signal indicative of a frame-capture rate of the camera to the tracked object.

Aspect 40. The apparatus of any one of aspect 29 to 39, further comprising an array of cameras including the camera.

Aspect 41. The apparatus of any one of aspect 29 to 40, wherein the at least one processor is configured to transmit, to the tracked object, via the communication unit, a signal indicative of a distance between the apparatus and the camera and the tracked object.

Aspect 42. The apparatus of any one of aspect 29 to 41, wherein the at least one processor is configured to transmit, to the tracked object, via the communication unit, a signal indicative of a pose of the tracked object.

Aspect 43. The apparatus of any one of aspect 29 to 42, wherein the apparatus comprise a head-mounted device.

Aspect 44. A system comprising the apparatus of aspect 2 and the apparatus of claim 28.

Aspect 45. An apparatus enabling tracking of an object, the apparatus comprising: a body comprising a handle to be held in a hand of a user; a plurality of light sources arranged on the body; and at least one processor configured to control the plurality of light sources to enable an object-tracking system to determine a pose of the body based on images of the plurality of light sources.

Aspect 46. An apparatus for tracking an object, the apparatus comprising: a camera configured to capture a plurality of images of a tracked object; a communication unit configured to communicate with the tracked object; and at least one processor configured to determine a pose of the tracked object based on the plurality of images of the tracked object.

Aspect 47. A method for enabling tracking of an object, the method comprising: controlling a plurality of light sources to enable an object-tracking system to determine a pose of a body on which the plurality of light sources are arranged based on images of the plurality of light sources.

Aspect 48. A method for enabling tracking of an object, the method comprising: adaptively adjusting a pattern of a plurality of light sources to enable an object-tracking system to track a body on which the plurality of light sources are arranged based on images of the plurality of light sources.

Aspect 49. A method for tracking an object, the method comprising: capturing a plurality of images of a tracked object; communicating with the tracked object; and determining a pose of the tracked object based on the plurality of images of the tracked object.

Aspect 50. A method for tracking an object, the method comprising: capturing a plurality of images of a tracked object; communicating with the tracked object; and tracking the tracked object based on the plurality of images of the tracked object.

Aspect 51. A method for enabling tracking of an object, the method comprising: controlling a plurality of light sources to enable an object-tracking system to track a body on which the plurality of light sources are arranged based on images of the plurality of light sources

Aspect 52. A method comprising operations according to any of aspect 1 to 46.

Aspect 53. A non-transitory computer-readable storage medium having stored thereon instructions that, when executed by at least one processor, cause the at least one processor to perform operations according to any of aspect 1 to 46.

Aspect 54. An apparatus for enabling tracking of an object, the apparatus including one or more means for performing operations described herein.

Aspect 55. An apparatus for tracking an object, the apparatus including one or more means for performing operations described herein.

Aspect 56. An apparatus for tracking, the apparatus comprising: a body comprising a handle; a plurality of light sources arranged on the body; and at least one processor configured to control the plurality of light sources to enable an object-tracking system to track the body based on images of the plurality of light sources.

Aspect 57. The apparatus of aspect 56, wherein, to control the plurality of light sources, the at least one processor is configured to independently control each light source of the plurality of light sources.

Aspect 58. The apparatus of any one of aspects 56 or 57, wherein, to control the plurality of light sources, the at least one processor is configured to at least one of: control which light sources of the plurality of light sources are illuminated; control a timing of illuminating the plurality of light sources; control an intensity of illuminating the plurality of light sources; or control wavelengths of light emitted by the plurality of light sources.

Aspect 59. The apparatus of any one of aspects 56 to 58, wherein the at least one processor is further configured to control which light sources of the plurality of light sources are illuminated based on a distance between the body and a camera of the object-tracking system.

Aspect 60. The apparatus of aspect 59, wherein the at least one processor is further configured to illuminate a first group of the plurality of light sources responsive to the body being less than a threshold distance from the camera.

Aspect 61. The apparatus of any one of aspects 59 or 60, wherein the at least one processor is further configured to illuminate a second group of the plurality of light sources responsive to the body being greater than a threshold distance from the camera.

Aspect 62. The apparatus of any one of aspects 59 to 61, further comprising a communication unit configured to receive a signal from the object-tracking system, wherein the at least one processor is further configured to determine the distance between the body and the camera based on the signal.

Aspect 63. The apparatus of any one of aspects 56 to 62, wherein the at least one processor is further configured to control which light sources of the plurality of light sources are illuminated based on a pose of the body relative to a hand of a user in contact with the handle.

Aspect 64. The apparatus of aspect 63, further comprising a touch sensor coupled to the body, wherein the at least one processor is further configured to determine the pose of the body relative to the hand using on the touch sensor.

Aspect 65. The apparatus of any one of aspects 56 to 64, wherein the at least one processor is further configured to control which light sources of the plurality of light sources are illuminated based on a pose of the body relative to a camera of the object-tracking system.

Aspect 66. The apparatus of aspect 65, further comprising a communication unit configured to receive a signal from the object-tracking system, wherein the at least one processor is further configured to determine the pose of the body relative to the camera of the object-tracking system based on the signal.

Aspect 67. The apparatus of any one of aspects 56 to 66, further comprising a communication unit configured to receive signals from the object-tracking system; wherein the at least one processor is further configured to control the plurality of light sources based on a signal from the object-tracking system.

Aspect 68. The apparatus of aspect 67, wherein: the signal indicates that the object-tracking system is verifying the apparatus; and the at least one processor is further configured to control which light sources of the plurality of light sources that are illuminated based on the signal from the object-tracking system.

Aspect 69. The apparatus of any one of aspects 67 or 68, wherein: the signal is indicative of a frame-capture rate of a camera of the object-tracking system; and the at least one processor is further configured to control a timing of illuminating the plurality of light sources based on the frame-capture rate of the camera.

Aspect 70. The apparatus of any one of aspects 67 to 69, wherein: the signal indicates that the object-tracking system is tracking the apparatus; and the at least one processor is further configured to control intensity of illuminating the plurality of light sources based on the signal from the object-tracking system.

Aspect 71. The apparatus of any one of aspects 56 to 70, wherein the apparatus comprises a controller.

Aspect 72. An apparatus for tracking an object, the apparatus comprising: a camera configured to capture a plurality of images of a tracked object; a communication unit configured to send signals to the tracked object; and at least one processor configured to determine a pose of the tracked object based on the plurality of images of the tracked object.

Aspect 73. The apparatus of aspect 72, wherein the at least one processor is configured to transmit, to the tracked object, via the communication unit, a signal indicative of a distance between the camera and the tracked object.

Aspect 74. The apparatus of aspect 73, wherein the at least one processor is configured to detect the tracked object based on a group of light sources illuminated in an image of the plurality of images.

Aspect 75. The apparatus of any one of aspects 72 to 74, wherein the at least one processor is configured to: determine a pose of the tracked object relative to the camera; and transmit, to the tracked object, via the communication unit, a signal indicative of the pose of the tracked object relative to the camera.

Aspect 76. The apparatus of any one of aspects 72 to 75, wherein the at least one processor is configured to: determine a pose of the tracked object relative to a hand holding the tracked object; and transmit, to the tracked object, via the communication unit, a signal indicative of the pose of the tracked object relative to the hand.

Aspect 77. The apparatus of any one of aspects 72 to 76, wherein the communication unit is configured send a signal indicating that the apparatus is tracking the tracked object.

Aspect 78. The apparatus of any one of aspects 72 to 77, wherein the communication unit is configured send a signal indicative of a frame-capture rate of the camera to the tracked object.

Aspect 79. The apparatus of any one of aspects 72 to 78, wherein the at least one processor is configured to: detect the tracked object in a first image of the plurality of images; and transmit, to the tracked object, via the communication unit, a signal indicating that the apparatus is verifying the tracked object.

Aspect 80. The apparatus of aspect 79, wherein the at least one processor is configured to: detect the tracked object in a second image of the plurality of images; and verify the tracked object based on a group of light sources illuminated in the second image.

Aspect 81. The apparatus of any one of aspects 72 to 80, wherein the at least one processor is configured to: obtain a hand pose of a hand holding the tracked object; and determine a pose of the tracked object further based on the hand pose.

Aspect 82. The apparatus of aspect 81, wherein the at least one processor is configured to determine the hand pose based on the plurality of images.

Aspect 83. The apparatus of aspect 82, wherein the at least one processor is configured to: determine a plurality of image features based on the plurality of images; and determine the pose of the tracked object further based on the plurality of image features.

Aspect 84. The apparatus of aspect 83, wherein the plurality of image features are based on at least one of representations of the tracked object in the plurality of images or representations of a hand holding the tracked object in the plurality of images.

Aspect 85. The apparatus of any one of aspects 72 to 84, wherein the apparatus comprises a head-mounted device.

Aspect 86. A method for enabling tracking of an object, the method comprising: controlling a plurality of light sources arranged on a body of an object to enable an object-tracking system to track the body based on images of the plurality of light sources.

Aspect 87. The method of aspect 86, wherein controlling the plurality of light sources comprises independently controlling each light source of the plurality of light sources.

Aspect 88. The method of any one of aspects 86 or 87, wherein controlling the plurality of light sources comprises controlling at least one of: which light sources of the plurality of light sources are illuminated; a timing of illuminating the plurality of light sources; an intensity of illuminating the plurality of light sources; or wavelengths of light emitted by the plurality of light sources.

Aspect 89. The method of any one of aspects 86 to 88, further comprising controlling which light sources of the plurality of light sources are illuminated based on a distance between the body and a camera of the object-tracking system.

Aspect 90. The method of aspect 89, further comprising illuminating a first group of the plurality of light sources responsive to the body being less than a threshold distance from the camera.

Aspect 91. The method of any one of aspects 89 or 90, further comprising illuminating a second group of the plurality of light sources responsive to the body being greater than a threshold distance from the camera.

Aspect 92. The method of any one of aspects 89 to 91, further comprising receiving a signal from the object-tracking system, wherein the at least one processor is further configured to determine the distance between the body and the camera based on the signal.

Aspect 93. The method of any one of aspects 86 to 92, further comprising controlling which light sources of the plurality of light sources are illuminated based on a pose of the body relative to a hand of a user in contact with the handle.

Aspect 94. The method of aspect 93, further comprising determining the pose of the body relative to the hand using on a touch sensor.

Aspect 95. The method of any one of aspects 86 to 94, further comprising controlling which light sources of the plurality of light sources are illuminated based on a pose of the body relative to a camera of the object-tracking system.

Aspect 96. The method of aspect 95, further comprising: receiving a signal from the object-tracking system; and determining the pose of the body relative to the camera of the object-tracking system based on the signal.

Aspect 97. The method of any one of aspects 86 to 96, further comprising: receiving signals from the object-tracking system; and controlling the plurality of light sources based on a signal from the object-tracking system.

Aspect 98. The method of aspect 97, wherein the signal indicates that the object-tracking system is verifying the apparatus; and further comprising controlling which light sources of the plurality of light sources that are illuminated based on the signal from the object-tracking system.

Aspect 99. The method of any one of aspects 97 or 98, wherein the signal is indicative of a frame-capture rate of a camera of the object-tracking system; and further comprising controlling a timing of illuminating the plurality of light sources based on the frame-capture rate of the camera.

Aspect 100. The method of any one of aspects 97 to 99, wherein the signal indicates that the object-tracking system is tracking the apparatus; and further comprising controlling intensity of illuminating the plurality of light sources based on the signal from the object-tracking system.

Aspect 101. The method of any one of aspects 86 to 100, wherein the object comprises a controller.

Aspect 102. A method for tracking an object, the method comprising: obtaining a plurality of images of a tracked object; sending signals to the tracked object; and determining a pose of the tracked object based on the plurality of images of the tracked object.

Aspect 103. The method of aspect 102, further comprising transmitting, to the tracked object, a signal indicative of a distance between the camera and the tracked object.

Aspect 104. The method of aspect 103, further comprising detecting the tracked object based on a group of light sources illuminated in an image of the plurality of images.

Aspect 105. The method of any one of aspects 102 to 104, further comprising: determining a pose of the tracked object relative to the camera; and transmitting, to the tracked object, via the communication unit, a signal indicative of the pose of the tracked object relative to the camera.

Aspect 106. The method of any one of aspects 102 to 105, further comprising: determining a pose of the tracked object relative to a hand holding the tracked object; and transmitting, to the tracked object, a signal indicative of the pose of the tracked object relative to the hand.

Aspect 107. The method of any one of aspects 102 to 106, further comprising sending a signal indicating that the apparatus is tracking the tracked object.

Aspect 108. The method of any one of aspects 102 to 107, further comprising sending a signal indicative of a frame-capture rate of the camera to the tracked object.

Aspect 109. The method of any one of aspects 102 to 108, further comprising: detecting the tracked object in a first image of the plurality of images; and transmitting, to the tracked object, a signal indicating that the apparatus is verifying the tracked object.

Aspect 110. The method of any one of aspects 102 to 109, further comprising: detecting the tracked object in a second image of the plurality of images; and verifying the tracked object based on a group of light sources illuminated in the second image.

Aspect 111. The method of any one of aspects 102 to 110, further comprising: obtaining a hand pose of a hand holding the tracked object; and determining a pose of the tracked object further based on the hand pose.

Aspect 112. The method of aspect 111, further comprising determining the hand pose based on the plurality of images.

Aspect 113. The method of any one of aspects 102 to 112, further comprising: determining a plurality of image features based on the plurality of images; and determining the pose of the tracked object further based on the plurality of image features.

Aspect 114. The method of aspect 113, wherein the plurality of image features are based on at least one of representations of the tracked object in the plurality of images or representations of a hand holding the tracked object in the plurality of images.

Aspect 115. The method of any one of aspects 102 to 114, performed by a head-mounted device.

Aspect 116. A non-transitory computer-readable storage medium having stored thereon instructions that, when executed by at least one processor, cause the at least one processor to perform operations according to any of aspects 86 to 115.

Aspect 117 An apparatus for providing virtual content for display, the apparatus comprising one or more means for perform operations according to any of aspects 86 to 115.

1-30. (canceled)

31. An apparatus enabling tracking of an object, the apparatus comprising:
a body comprising a handle to be held in a hand of a user;
a plurality of light sources arranged on the body; and
at least one processor configured to adaptively adjust a pattern of the plurality of light sources to enable an object-tracking system to track the body based on images of the plurality of light sources.

32. An apparatus enabling tracking of an object, the apparatus comprising:
a body comprising a handle to be held in a hand of a user;
a plurality of light sources arranged on the body; and
at least one processor configured to control the plurality of light sources to enable an object-tracking system to track the body based on images of the plurality of light sources.

33. The apparatus of claim 32, wherein, to control the plurality of light sources, the at least one processor is configured to independently control each light source of the plurality of light sources.

34. The apparatus of claim 32, wherein, to control the plurality of light sources, the at least one processor is configured to control at least one of:
light sources of the plurality of light sources that are illuminated;
a timing of illuminating the plurality of light sources;
an intensity of illuminating the plurality of light sources; or
wavelengths of light produced by the plurality of light sources.

35. The apparatus of claim 32, wherein each light source of the plurality of light sources comprises one or more respective light-emitting diodes (LEDs).

36. The apparatus of claim 32, wherein each light source of the plurality of light sources is configured to emit at least one of visible light, near infrared light, or infrared light.

37. The apparatus of claim 32, wherein the at least one processor is further configured to control the plurality of light sources based on a distance between the body and a camera of the object-tracking system.

38. The apparatus of claim 37, wherein the at least one processor is further configured to control which light sources of the plurality of light sources are illuminated based on the distance between the body and the camera.

39. The apparatus of claim 37, wherein the at least one processor is further configured to:
determine whether the body is greater than a threshold distance from the camera of the object-tracking system; and
control the plurality of light sources based on whether the body is greater than the threshold distance from the camera.

40. The apparatus of claim 39, wherein the at least one processor is further configured to:
illuminate a first group of the plurality of light sources responsive to the body being less than the threshold distance from the camera; and
illuminate a second group of the plurality of light sources responsive to the body being greater than the threshold distance from the camera.

41. The apparatus of claim 40, wherein the second group comprises fewer light sources than the first group.

42. The apparatus of claim 37, further comprising a communication unit configured to receive a signal from the object-tracking system, wherein the at least one processor is further configured to determine the distance between the body and the camera based on the signal.

43. The apparatus of claim 42, wherein the at least one processor is further configured to determine the distance between the body and the camera based on a strength of the signal.

44. The apparatus of claim 42, wherein the at least one processor is further configured to determine the distance between the body and the camera based on a message encoded by the signal.

45. The apparatus of claim 37, wherein, to control the plurality of light sources based on the distance between the body and a camera of the object-tracking system, the at least one processor is configured to control at least one of:
which light sources of the plurality of light sources are illuminated;
a timing of illuminating the plurality of light sources;
an intensity of illuminating the plurality of light sources; or
wavelengths of light produced by the plurality of light sources.

46. The apparatus of claim 32, wherein the at least one processor is further configured to control the plurality of light sources based on a pose of the body.

47. The apparatus of claim 46, wherein the at least one processor is further configured to control which light sources of the plurality of light sources are illuminated based on a pose of the body relative to the hand of the user.

48. The apparatus of claim 46, wherein the at least one processor is further configured to control which light sources of the plurality of light sources are illuminated based on a pose of the body relative to a camera of the object-tracking system.

49. The apparatus of claim 46, further comprising a communication unit configured to receive a signal from the object-tracking system, wherein the at least one processor is further configured to determine a pose of the body relative to a camera of the object-tracking system based on the signal.

50. A method for tracking an object, the method comprising:
capturing a plurality of images of a tracked object;
communicating with the tracked object; and
determining a pose of the tracked object based on the plurality of images of the tracked object.
